(19) United States
(12) Patent Application Publication
(10) Pub. No.: US 2014/0329416 A1
(43) Pub. Date: Nov. 6, 2014

(54) CONNECTORS FOR ELECTRONIC DEVICES

(71) Applicants: Albert J. Golko, Saratoga, CA (US); Eric S. Jol, San Jose, CA (US); Mathias Schmidt, Mountain View, CA (US); Jesse L. Dorogusker, Los Altos, CA (US); Hugo Fiennes, Palo Alto, CA (US); Jeffrey J. Terlizzi, San Francisco, CA (US)

(72) Inventors: Albert J. Golko, Saratoga, CA (US); Eric S. Jol, San Jose, CA (US); Mathias Schmidt, Mountain View, CA (US); Jesse L. Dorogusker, Los Altos, CA (US); Hugo Fiennes, Palo Alto, CA (US); Jeffrey J. Terlizzi, San Francisco, CA (US)

(73) Assignee: APPLE INC.

(21) Appl. No.: 14/357,200

(22) PCT Filed: Sep. 7, 2012
(86) PCT No.: PCT/US2012/054318

§ 371 Date: May 8, 2014

Related U.S. Application Data
(60) Provisional application No. 61/565,328, filed on Nov. 30, 2011.

(51) Int. Cl. H01R 24/60; H01R 29/00

(52) U.S. Cl. CPC H01R 24/60; H01R 29/00
USPC 439/676

(57) ABSTRACT

A dual orientation connector having a connector tab with first and second major opposing sides and a plurality of electrical contacts carried by the connector tab. The plurality of contacts includes a first set of external contacts formed at the first major side and a second set of external contacts formed at the second major side. The first plurality of contacts are symmetrically spaced with the second plurality of contacts and the connector tab is shaped to have 180 degree symmetry so that it can be inserted and operatively coupled to a corresponding receptacle connector in either of two insertion orientations.

### CROSS-REFERENCES TO RELATED APPLICATIONS

This application claims the benefit of U.S. Provisional Patent Application No. 61/565,328, filed Nov. 30, 2011, and entitled “CONNECTORS FOR ELECTRONIC DEVICES,” which is incorporated herein by reference for all purposes.

### BACKGROUND OF THE INVENTION

The present invention relates generally to input/output electrical connectors such as audio connectors and data connectors.

Standard audio connectors or plugs are available in three sizes according to the outside diameter of the plug: a 6.35 mm (¼″) plug, a 3.5 mm (⅛″) miniature plug and a 2.5 mm ( 3/32″) subminiature plug. The plugs include multiple conductive regions that extend along the length of the connectors in distinct portions of the plug such as the tip, sleeve and one or more middle portions between the tip and sleeve resulting in the connectors often being referred to as TRS (tip, ring and sleeve) connectors.

FIGS. 1A and 1B illustrate examples of audio plugs 10 and 20 having three and four conductive portions, respectfully. As shown in FIG. 1A, plug 10 includes a conductive tip 12, a conductive sleeve 16 and a conductive ring 14 electrically isolated from the tip 12 and the sleeve 16 by insulating rings 17 and 18. The three conductive portions 12, 14, 16 are for left and right audio channels and a ground connection. Plug 20, shown in FIG. 1B, includes four conductive portions: a conductive tip 22, a conductive sleeve 26 and two conductive rings 24, 25 and is thus sometime referred to as a TRRS (tip, ring, ring, sleeve) connector. The four conductive portions are electrically isolated by insulating rings 27, 28 and 29 and are typically used for left and right audio, microphone and ground signals. As evident from FIGS. 1A and 1B, each of audio plugs 10 and 20 are orientation agnostic. That is, the conductive portions completely encircle the connector forming 360 degree contacts such that there is no distinct top, bottom or side to the plug portion of the connectors.

When plugs 10 and 20 are 3.5 mm miniature connectors, the outer diameter of conductive sleeve 16, 26 and conductive rings 14, 24, 25 is 3.5 mm and the insertion length of the connector is 14 mm. For 2.5 mm subminiature connectors, the outer diameter of the conductive sleeve is 2.5 mm and the insertion length of the connector is 11 mm long. Such TRS and TRRS connectors are used in many commercially available MP3 players and smart phones as well as other electronic devices. Electronic devices such as MP3 players and smart phones are continuously being designed to be thinner and smaller and/or to include video displays with screens that are pushed out as close to the outer edge of the devices as possible. The diameter and length of current 3.5 mm and even 2.5 mm audio connectors are limiting factors in making such devices smaller and thinner and in allowing the displays to be larger for a given form factor.

Many standard data connectors are also only available in sizes that are limiting factors in making portable electronic devices smaller. Additionally, and in contrast to the TRS connectors discussed above, many standard data connectors require that they be mated with a corresponding connector in a single, specific orientation. Such connectors can be referred to as polarized connectors. As an example of a polarized connector, FIGS. 2A and 2B depict a micro-USB connector 30, the smallest of the currently available USB connectors. Connector 30 includes a body 32 and a metallic shell 34 that extends from body 32 and can be inserted into a corresponding receptacle connector. As shown in FIGS. 2A, 2B, shell 34 has angled corners 35 formed at one of its bottom plates. Similarly, the receptacle connector (not shown) with which connector 30 mates has an insertion opening with matching angled features that prevents shell 34 from being inserted into the receptacle connector the wrong way. That is, it can only be inserted one way - in an orientation where the angled portions of shell 34 align with the matching angled portions in the receptacle connector. It is sometimes difficult for the user to determine when a polarized connector, such as connector 30 is oriented in the correct insertion position.

Connector 30 also includes an interior cavity 38 within shell 34 along with contacts 36 formed within the cavity. Cavity 38 is prone to collecting and trapping debris within the cavity which may sometimes interfere with the signal connections to contacts 36. Also, and in addition to the orientation issue, even when connector 30 is properly aligned, the insertion and extraction of the connector is not precise, and may have an inconsistent feel. Further, even when the connector is fully inserted, it may have an undesirable degree of wobble that may result in either a faulty connection or breakage.

Many other commonly used data connectors, including standard USB connectors, mini USB connectors, FireWire connectors, as well as many of the proprietary connectors used with common portable media electronics, suffer from some or all of these deficiencies or from similar deficiencies.

### BRIEF SUMMARY OF THE INVENTION

Various embodiments of the invention pertain to plug connectors and receptacle connectors that improve upon some or all of the above described deficiencies. Other embodiments of the invention pertain to methods of manufacturing such plug and/or receptacle connectors as well as electronic devices that include such connectors. Embodiments of the invention are not limited to any particular type of connector and may be used for numerous applications. Some embodiments, however, are particularly well suited for use as audio connectors and some embodiments are particularly well suited for data connectors.

In view of the shortcomings in currently available audio and data connectors as described above, some embodiments of the present invention relate to improved audio and/or data plug connectors that have a reduced plug length and thickness, an intuitive insertion orientation and a smooth, consistent feel when inserted and extracted from its corresponding receptacle connector. Additionally, some embodiments of plug connectors according to the present invention have external contacts instead of internal contacts and do not include a cavity that is prone to collecting and trapping debris.

One particular embodiment of the invention pertains to a dual orientation plug connector having external contacts carried by a connector tab. The connector tab can include first and second opposing sides with a first set of contacts formed on the first side and a second set of contacts formed on the second side. The first set of contacts can be symmetrically spaced with the second set of contacts and the connector tab can have a 180 degree symmetrical shape so that it can be inserted and operatively coupled to a corresponding receptacle connector in either of two insertion orientations. In some embodiments the first and second sets of contacts each include an odd number of contacts spaced apart in first and second rows, respectively, with a central contact centered in each of the first and second rows dedicated for a digital data signal. In some embodiments the first and second sets of contacts each include an even number of contacts spaced apart in first and second rows, respectively, with the two innermost contacts in each row being dedicated for a digital data signal and power such that the two contacts designated for power are positioned in a cater corner relationship with each other and the two contacts designated for digital data signals are in a cater corner relationship with each other.

In some embodiments the plug connector further includes one or more ground contacts formed on side surfaces of the connector tab that extend between the first and second surfaces, and in some additional embodiments the connector tab includes a cap or ground ring that covers the tip of the connector and extends from the tip towards the body along at least a portion of each of the side surfaces. In some embodiments the metal ground ring generally defines a shape of the connector tab and includes openings on both the first and second surfaces in which the first and second sets of contacts are respectively formed and surrounded by a dielectric. Still in some other embodiments, the body includes a flexible member or is made from a flexible material that allows the connector to bend with respect to an insertion axis in which the connector is mated with a receptacle connector. In some further embodiments, the connector tab includes at least one retention feature adapted to engage with a retention feature on a corresponding receptacle connector.

Other embodiments of the invention pertain to electrical receptacle connectors having a pinout that matches or corresponds to the pinout of the above-described plug connectors. In one embodiment, the receptacle connector can include a housing that defines an interior cavity extending in a direction of the depth of the housing and a plurality of electrical contacts positioned within the cavity. The cavity can have a 180 degree symmetrical shape so that a corresponding plug connector can be inserted into the cavity in either of two insertion orientations. Additionally, the plurality of contacts may include a first set of contacts positioned at a first interior surface of the cavity and a second set of contacts positioned at a second interior surface of the cavity spaced apart from the first interior surface in an opposing relationship. The first and second sets of contacts can further be mirror images of each other. In some embodiments, the receptacle connector can also include at least one retention feature adapted to engage with a retention feature on a corresponding plug connector. In still other embodiments, the receptacle connector can include first and second retention features positioned on opposing side surfaces the cavity adapted to engage with first and second retention features on a corresponding plug connector.

To better understand the nature and advantages of the present invention, reference should be made to the following description and the accompanying figures. It is to be understood, however, that each of the figures is provided for the purpose of illustration only and is not intended as a definition of the limits of the scope of the present invention. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIGS. 1A and 1B show perspective views of previously known TRS audio plug connectors;

FIG. 2A shows a perspective view of a previously known micro-USB plug connector while FIG. 2B shows a front plan view of the micro-USB connector shown in FIG. 2A;

FIG. 3A is simplified top view of a plug connector 40 according to one embodiment of the present invention;

FIGS. 3B and 3C are simplified side and front views, respectively, of connector 40 shown in FIG. 3A;

FIGS. 4A-4C are front view of alternative embodiments of connector 40 according to the present invention;

FIGS. 5A-5H are simplified top views of contact layouts within contact region 46 of connector 40 according to different embodiments of the invention;

FIG. 6A is simplified view of contact region 46a of plug connector 50 and FIG. 6B is simplified view of contact region 46a of plug connector 50 shown in FIGS. 3A and 3B according to a specific embodiment of the present invention;

FIGS. 7A and 7B are diagrams depicting a set of exemplary contact locations according to some embodiments of the present invention;

FIGS. 8A-8C are simplified top, bottom and side plan views of a plug contact connector that includes an orientation key according to another embodiment of the present invention;

FIGS. 9A-9F are simplified schematic representations of contact arrangements of connectors according to additional embodiments of the invention;

FIGS. 10A and 10B are diagrams depicting a set of exemplary contact locations according to some other embodiments of the present invention;

FIG. 11A is a simplified side cross-sectional view of a plug connector 90 according to one embodiment of the present invention;

FIG. 11B is a simplified side view of plug connector 90 shown in FIG. 11A that illustrates how the connector may bend when extracted from a receptacle connector by being pulled in a direction that intersects the connector's axis of insertion;

FIG. 12A is simplified top view of a plug connector 100 according to another embodiment of the present invention;

FIG. 12B is a simplified side view of connector 100 shown in FIG. 12A;

FIGS. 13A and 13B are simplified perspective views of a ground ring that can be included in some embodiments of the present invention;

FIG. 14A is a simplified top perspective view and FIG. 14B is a simplified bottom plan view of an audio plug connector 110 according to one embodiment of the present invention;

FIGS. 15A and 15B are diagrams depicting an exemplary pinout of one particular implementation of connector 110 shown in FIGS. 14A and 14B;

FIG. 16A is a simplified top perspective view and FIG. 16B is a simplified bottom plan view of an audio plug connector 120 according to one embodiment of the present invention;

FIGS. 17A and 17B are diagrams depicting an exemplary pinout of one particular implementation of connector 120 shown in FIGS. 16A and 16B;

FIG. 18A is a simplified top perspective view and FIG. 18B is a simplified bottom plan view of an audio plug connector 130 according to one embodiment of the present invention

FIGS. 19A and 19B are diagrams depicting an exemplary pinout of one particular implementation of connector 130 shown in FIGS. 18A and 18B;

FIG. 20A is a simplified top perspective view and FIG. 20B is a simplified bottom plan view of an audio plug connector 140 according to one embodiment of the present invention;

FIGS. 21A and 21B are diagrams depicting an exemplary pinout of one particular implementation of connector 140 shown in FIGS. 20A and 20B;

FIG. 22A is a simplified top perspective view and FIG. 22B is a simplified bottom plan view of an audio plug connector 150 according to one embodiment of the present invention;

FIGS. 23A and 23B are diagrams depicting an exemplary pinout of one particular implementation of connector 150 shown in FIGS. 22A and 22B;

FIG. 24 is a simplified perspective view of a connector plug 160 according to another embodiment of the invention.

FIGS. 25A-25D illustrate one example of a connector 170 having three contacts formed on top and bottom opposing surfaces as well as a fiber optic cable 175 that runs through the center of the connector;

FIG. 26 is a simplified illustrative block diagram of an electronic media device suitable in which embodiments of the invention may be incorporated or used with; and

FIG. 27 depicts an illustrative rendering of one particular embodiment of an electronic media device suitable for use with embodiments of the present invention.

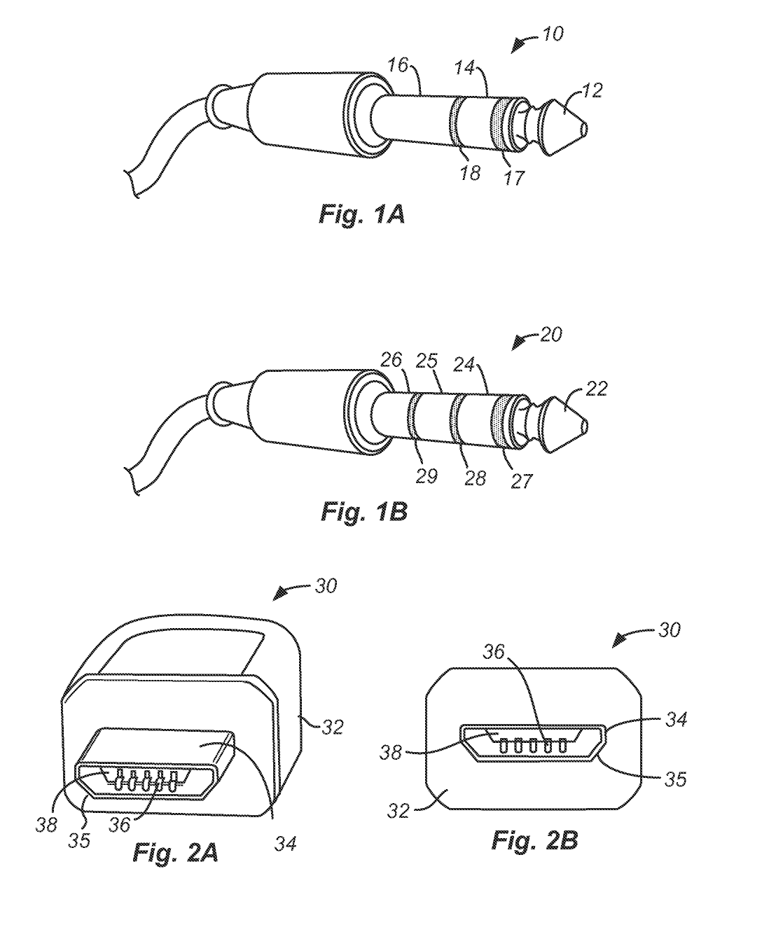

### DETAILED DESCRIPTION OF THE INVENTION

The present invention will now be described in detail with reference to certain embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known details have not been described in detail in order not to unnecessarily obscure the present invention.

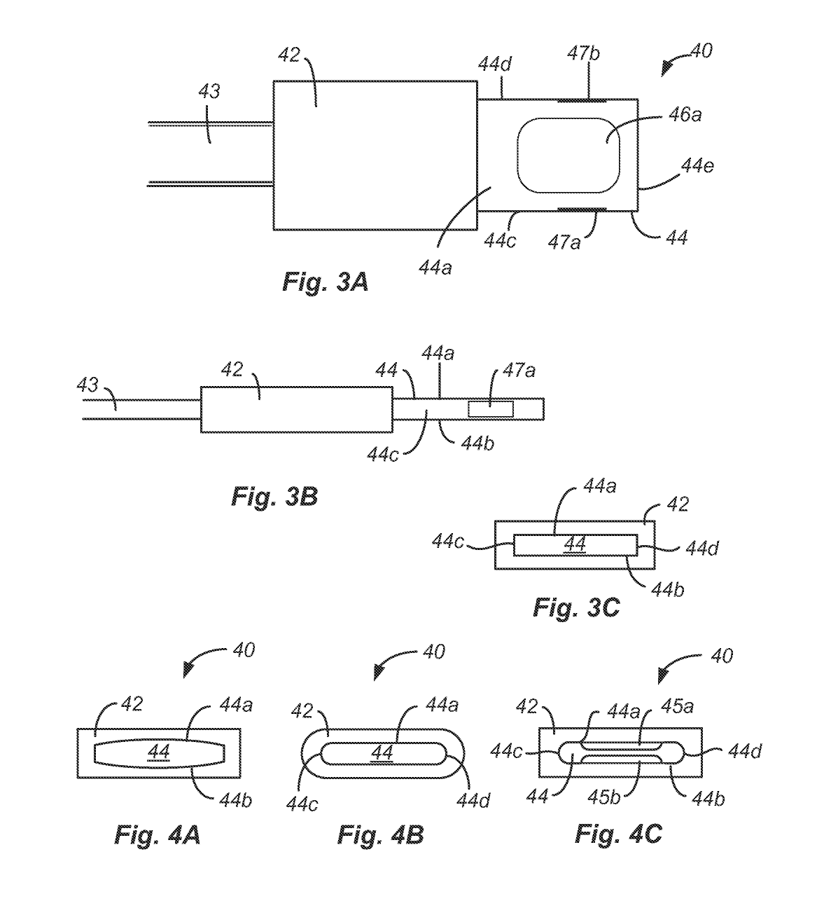

In order to better appreciate and understand the present invention, reference is first made to FIGS. 3A-3C, which are simplified top, side and front views, respectively, of a plug connector 40 according to one embodiment of the present invention. Connector 40 includes a body 42 and a tab portion 44. A cable 43 is attached to body 42 and tab portion 44 extends away from body 42 in a direction parallel to the length of the connector 40. Tab 44 is sized to be inserted into a corresponding receptacle connector during a mating event and includes a first contact region 46a formed on a first major surface 44a and a second contact region 46b (not shown in FIGS. 3A-3C) formed at a second major surface 44b opposite surface 44a. A plurality of contacts (not shown in FIGS. 3A-3C) can be formed in each of contact regions 46a and 46b such that, when tab 44 is inserted into a corresponding receptacle connector, contacts in regions 46a, 46b are electrically coupled to corresponding contacts in the receptacle connector. In some embodiments, the plurality of contacts are self-cleaning wiping contacts that, after initially coming into contact with a receptacle connector contact during a mating event, slide further past the receptacle connector contact with a wiping motion before reaching a final, desired contact position.

Tab 44 also includes first and second opposing side surfaces 44c, 44d that extend between the first and second major surfaces 44a, 44b. While tab 44 is shown in FIGS. 3A-3C as having a substantially rectangular and substantially flat shape, in some embodiments of the invention first and second major surfaces 44a, 44b may have matching convex or concave curvatures to them or may have a matching recessed region centrally located between the sides of tab 44. Contact regions 46a and 46b may be formed in the recessed regions and the recessed regions may, for example, extend from the distal tip of tab 44 all the way to base 42 or may extend along only a portion of the length of tab 44 (e.g., between ½ to ¾ of the length of the tab) ending at a point short of base 42. Side surfaces 44c and 44d may also have matching convex or concave curvatures.

Generally, the shape and curvature of surfaces 44a and 44b mirror each other, as do the shape and curvature of surfaces 44a and 44b, in accordance with the dual orientation design of connector 40 as described below. Additionally, while FIGS. 3A-3C show surfaces 44c, 44d as having a width significantly less than that of surfaces 44a, 44b (e.g., less than or equal to one half width of surfaces 44a, 44b), in some embodiments of the invention side surfaces 44c, 44d have a width that is relatively close to or even equal with or wider than that of surfaces 44a, 44b.

FIGS. 4A-4C are simplified front plan views of embodiments of connector 40 in which body 42 and/or tab 44 have different cross-sectional shapes. For example, in FIG. 4A, major surfaces 44a and 44b are slightly convex, while in FIGS. 4B and 4C, side surfaces 44c and 44d are rounded. Further, FIG. 4C depicts an example of a connector having recessed regions 45a and 45b formed at major surfaces 44a and 44b, respectfully, of tab 44. The recessed regions extend from the distal tip of tab 44 along a portion of the length of tab 44 and are centrally located between side surfaces 44c and 44d. A person of skill in the art will understand that FIGS. 3C and 4A-4C are but examples of suitable cross-sectional shapes for body 42 and tab 44 and that many other cross-sectional shapes may be employed for each of body 42 and tab 44 in various embodiments of the invention.

In some embodiments, one or more ground contacts can be formed on the side surfaces. For example, FIGS. 3A and 3B show a ground contact 47a formed on first side surface 44c and a ground contact 47b formed on second side surface 44d opposite ground contact 47a. As another example, one or more ground contacts may be formed on end surface 44e at the distal tip of connector 40 in addition to, or instead of ground contacts 47a, 47b. In some embodiments, each of the one or more ground contacts can be formed on or form part of an outer portion of its respective side surface. In other embodiments, the one or more ground contacts can be formed within and/or as part of a pocket, indentation, notch or similar recessed region formed on each of the side surfaces 44c, 44d that operatively engage with a retention mechanism in a corresponding receptacle connector as described in detail below.

Body 42 is generally the portion of connector 40 that a user will hold onto when inserting or removing connector 40 from a corresponding receptacle connector. Body 42 can be made out of a variety of materials and in some embodiments is made from a dielectric material, such as a thermoplastic polymer formed in an injection molding process. While not shown in FIGS. 3A or 3B, a portion of cable 43 and a portion of tab 44 may extend within and be enclosed by body 42. Also, electrical contact to the contacts in each of regions 46a, 46b can be made to individual wires in cable 43 within body 42. In one embodiment, cable 43 includes a plurality of individual insulated wires, one for each contact within regions 46a and 46b that are soldered to bonding pads on a printed circuit board (PCB) housed within body 42. Each bonding pad on the PCB is electrically coupled to a corresponding individual contact within one of contact regions 46a or 46b.

Tab 44 may also be made from a variety of materials including metal, dielectric or a combination thereof. In some embodiments, tab 44 includes a frame made primarily or exclusively from a metal, such as stainless steel, and contact regions 46a and 46b are formed within the frame. In some other embodiments, tab 44 includes a frame made primarily or exclusively from a dielectric material, such as a ceramic or an elastomeric material. For example, tab 44 may be a ceramic base that has contacts printed directly on its surfaces.

In embodiment illustrated in FIGS. 3A and 3B, body 42 has a rectangular cross section that generally matches in shape but is slightly larger than the cross section of tab 42. As discussed with respect to FIGS. 4A-4C, body 42 can be of a variety of shapes and sizes, however. For example, body 42 may have a rectangular cross section with rounded or angled edges (referred to herein as a “generally rectangular” cross section), a circular cross section, an oval cross section as well as many other suitable shapes. In some embodiments, both the body 42 and tab 44 of connector 40 have the same cross-sectional shape and have the same width and height (thickness). As one example, body 42 and tab 44 may combine to form a substantially flat, uniform connector where the body and tab seem as one. In still other embodiments, the cross section of body 42 has a different shape than the cross section of tab 44. As one example, body 42 may have curved upper and lower and/or curved side surfaces while tab 44 is substantially flat.

Each of contact regions 46a, 46b can be centered between opposing side surfaces 44c, 44d. Individual contacts in contact regions 46a and 46b can be external contacts positioned at an outer surface of tab 44 so that some embodiments of connector 40 do not include contacts positioned within an internal cavity in which particles and debris may collect. Each of contact regions 46a and 46b can include one or more contacts that can be made from copper, nickel, brass, a metal alloy or any other appropriate conductive material. In some embodiments contacts can be printed on surfaces 44a and 44b using techniques similar to those used to print contacts on printed circuit boards.

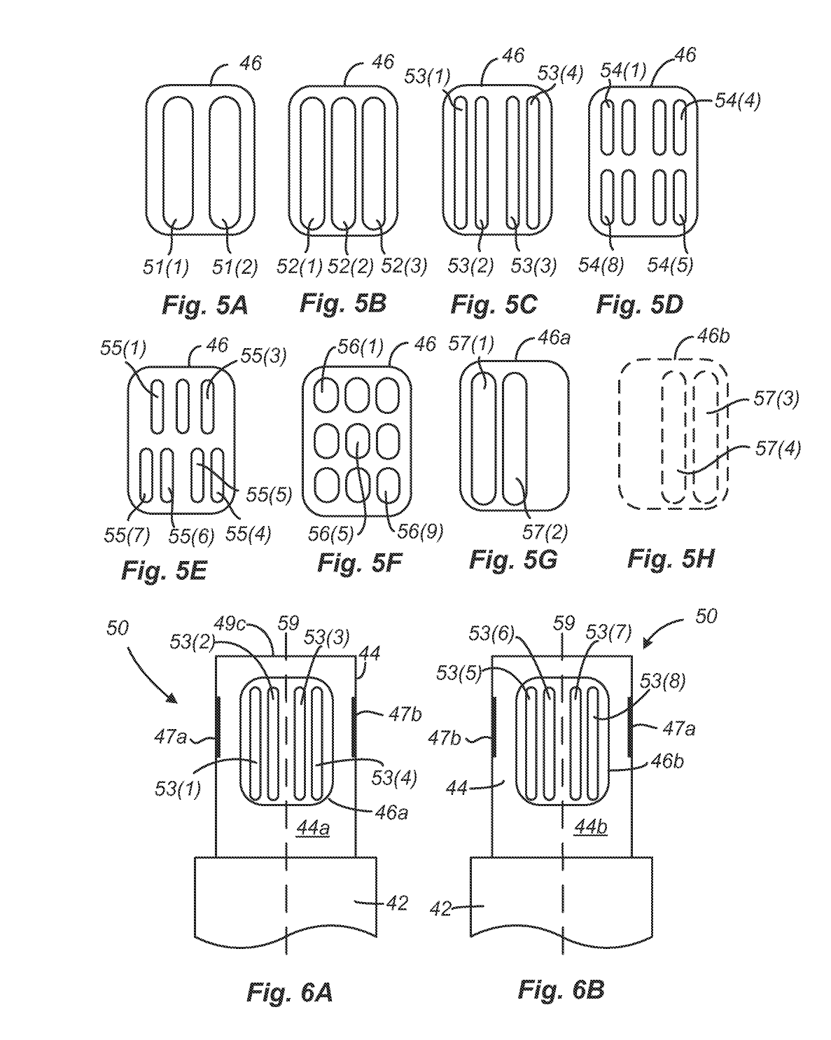

Contact regions 46a and 46b may include any number of contacts, from one to twenty or more arranged in a variety of different patterns. FIGS. 5A-5H provide different examples of contact arrangements within a contact region 46 according to different embodiments of the invention. As shown in FIG. 5A, contact region 46 may include two contacts 51(1) and 51(2) that are centered and symmetrically positioned within the contact region. Similarly, FIG. 5B depicts a contact region 46 having three contacts 52(1) . . . 52(3) centered and symmetrically positioned within the contact region, and FIG. 5C depicts a contact region 46 having four such contacts 53(1) . . . 53(4).

While each of FIGS. 5A-5C include a single row of contacts within region 46, some embodiments of the invention may include two, three or more rows of contacts. As examples, contact region 46 shown in FIG. 5D includes two rows of four contacts 54(1) . . . 54(4) and 54(5) . . . 54(8) with each row being centered between the sides of the contact region and symmetrically spaced with respect to a center line traversing the length of the contact region; FIG. 5E shows a contact region 46 having a first row of three contacts 55(1) . . . 51(3) and a second row of four contacts 55(4) . . . 55(7) positioned within the contact region; and FIG. 5F depicts a contact region 46 having three rows of three contacts for a total of nine contacts 56(1) . . . 56(9).

While each row of individual contacts in the contact regions shown in FIGS. 5A-5F center the contacts in the row between the sides of the contact region and symmetrically space the contacts with respect to a center line traversing the length of the contact region, in some embodiments of the invention the contacts need not be centered in this manner. As an example, FIG. 5G depicts a contact region 46a having two contacts 57(1) . . . 57(2) that are not centered within the contact region. To provide the 180 degree symmetry employed by some embodiments of the invention, a connector that includes the contact region 46a shown in FIG. 5G on one major surface, includes a contact region 46b as shown in FIG. 5H on the opposing major surface that matches contact region 46a. In FIG. 5H, contact region 46b and contacts 57(3)-57(4) are shown in dashed lines to represent the position of the contacts when looking from contact region 46a through the connector to contact region 46b.

Each of the contact regions 46 shown in FIGS. 5A-5G is representative of both regions 46a and 46b according to particular embodiments of the invention. That is, according to one embodiment of the invention, a plug connector 40 includes two contact regions 46a and 46b each of which includes two contacts as shown in region 46 in FIG. 5A. In another embodiment, a plug connector 40 includes contact regions 46a and 46b each of which includes three contacts as shown in FIG. 5B. Still other embodiments of the invention include: a connector 40 having contact regions 46a and 46b as shown in region 46 in FIG. 5C; a connector 40 having contact regions 46a and 46b as shown in region 46 in FIG. 5D; a connector 40 having contact regions 46a and 46b as shown in region 46 in FIG. 5E; a connector 40 having contact regions 46a and 46b as shown in region 46 in FIG. 5F; and a connector 40 having contact regions 46a and 46b as shown in region 46 in FIG. 5G.

Contacts within regions 46a, 46b may include contacts designated for a wide variety of signals including power contacts, ground contacts, analog contacts and digital contacts among others. In some embodiments, one or more ground contacts are formed in regions 46a and/or 46b while in other embodiments, ground contacts are only located at the tip 44e and/or on the side surfaces 44c, 44d of connector 40 in order to save space within contact regions 46a and 46b for power and signal contacts. Embodiments that employ ground contacts at one or more positions along the peripheral side and/or tip surfaces of connector 40 instead of within contact regions 46a and 46b may enable the overall footprint of connector tab 44 to be smaller than a similar connector that includes ground contacts in contact regions 46a or 46b.

Power contacts within regions 46a, 46b may carry signals of any voltage and, as an example, may carry signals between 2-30 volts. In some embodiments, multiple power contacts are included in regions 46a, 46b to carry power signals of different voltages levels that can be used for different purposes. For example, one or more contacts for delivering low current power at 3.3 volts that can be used to power accessory devices connected to connector 40 can be included in regions 46a, 46b as well as one or more contacts for delivering high current power at 5 volts for charging portable media devices coupled to connector 40.

Examples of analog contacts that may be included in contact regions 46a, 46b include contacts for separate left and right channels for both audio out and audio in signals as well as contacts for video signals, such as RGB video signals, YPbPr component video signals and others. Similarly, many different types of digital signals can be carried by contacts in regions 46a, 46b including data signals such as, USB signals (including USB 1.0, 2.0 and/or 3.0), FireWire (also referred to as IEEE 1394) signals, SATA signals and/or any other type of data signal. Digital signals within contact regions 46a, 46b may also include signals for digital video such as DVI signals, HDMI signals and Display Port signals, as well as other digital signals that perform functions that enable the detection and identification of devices or accessories to connector 40.

In some embodiments, dielectric material is filled in between individual contacts in contact regions 46a, 46b so that the dielectric material and contacts form a flush outer surface of tab 44 that provides a smooth, consistent feel across the surfaces of tab 44. Additionally, to improve robustness and reliability, connector 40 can be fully sealed and includes no moving parts.

Connector 40 can have a 180 degree symmetrical, double orientation design which enables,the connector to be inserted into a corresponding receptacle connector in both a first orientation where surface 44a is facing up or a second orientation where surface 44a is rotated 180 degrees and facing down. To allow for the orientation agnostic feature of connector 40, tab 44 is not polarized. That is, tab 44 does not include a physical key that is configured to mate with a matching key in a corresponding receptacle connector designed to ensure that mating between the two connectors occurs only in a single orientation. Instead, if tab 44 is divided into top and bottom halves along a horizontal plane that bisects the center of tab 44 along its width, the physical shape of the upper half of tab 44 can be substantially the same as the physical shape of the lower half. Similarly, if tab 44 is divided into left and right halves along a vertical plane that bisects the center of tab along its length, the physical shape of the left half of tab 44 can be substantially the same as the shape of the right half. Additionally, contacts can be positioned within contact regions 46a and 46b so that individual contacts in region 46a are arranged symmetric with the individual contacts in region 46b located on the opposite side of tab 44, and ground contacts formed at the tip or on the sides of connector tab 44 can also be arranged in a symmetric manner.

To better understand and appreciate the 180 degree symmetrical design of some embodiments of the invention, reference is made to FIGS. 6A and 6B which are simplified views of a first side 44a and an opposing second side 44b, respectively, of a plug connector 50 according to a specific embodiment of the invention that includes four individual contacts formed within each of contact regions 46a and 46b. For example, as shown in FIG. 6A, contact region 46a may include four evenly spaced contacts 53(1) . . . 53(4) formed within the region. With respect to a center plane 59 that is perpendicular to and passes through the middle of connector 50 along its length, contacts 53(1) and 53(2) are in a mirrored relationship with contacts 53(3) and 53(4). That is, the spacing from center line 59 to contact 53(2) is the same as the spacing from center line 59 to contact 53(3). Also, the spacing from center line 59 to contact 53(1) is the same as the spacing from centerline 59 to contact 53(4). Each of the pairs of contacts 53(1), 53(2) and 53(3), 53(4) are also spaced equally from the sides 44c and 44d of the connector with respect to each other and are spaced equally along the length of tab 44 between end surface 44e and body 42.

Similarly, in FIG. 6B contact region 44b includes the same number of contacts as region 44a that are also spaced according to the same spacing in region 44a. Thus, contact region 44b includes four contacts 53(5) . . . 53(8) spaced within region 46b according to the same layout and spacing as contacts 53(1) . . . 53(4) within regions 46a. Because the layout and spacing of contacts in regions 46a and 46b are identical, absent some sort of indicia or mark on one of surfaces 44a or 44b, the surfaces and contact layout on each of surfaces 44a, 44b looks the same. When connector 50 is inserted into a corresponding receptacle connector, the contacts in regions 46a, 46b will make proper electrical contact with contacts in the receptacle connector in either of two different orientations (referred to herein as “up” or “down” for convenience but it is to be appreciated that these are relative terms intended to connote a 180 degree change in the orientation of the connector only).

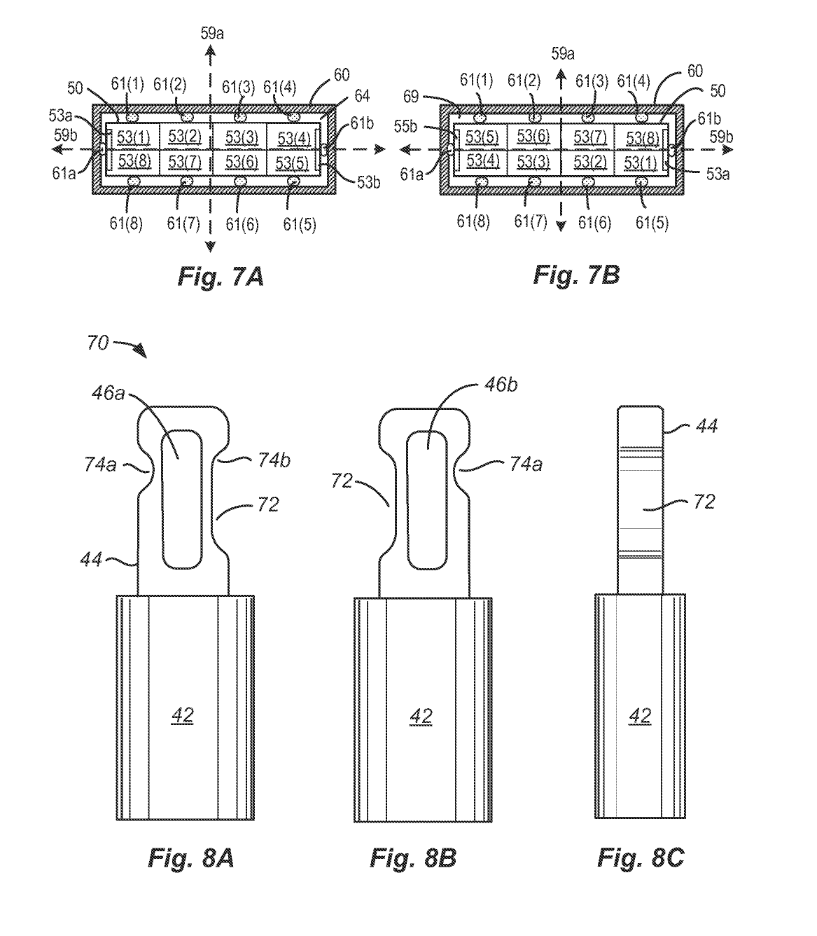

To further illustrate, reference is now made to FIGS. 7A and 7B, which schematically show a cross-sectional view of plug connector 50 having four contacts in each of regions 46a, 46b as depicted in FIGS. 6A and 6B inserted into a matching receptacle connector 60. Receptacle connector 60 includes a cavity 64 into which the tab of the plug connector can be inserted. Four contacts 61(1) . . . 61(4) extend from one interior surface of the receptacle connector into cavity 64 and four contacts 61(5) . . . 61(8) extend from the opposing interior surface into cavity 64 in an oppositional and mirrored relationship to contacts 61(1) . . . 61(4).

FIG. 7A depicts that when the connector 50 is inserted into cavity 65 in an “up” position, contact 53(1) of the plug connector aligns with contact 61(1) of the receptacle connector, contact 53(2) aligns with contact 61(2), contact 53(3) aligns with contact 61(3) and contact 53(4) aligns with contact 61(4). FIG. 7A also shows that, on the opposing surface, contact 53(5) aligns with contact 61(5), contact 53(6) aligns with contact 61(6), contact 53(7) aligns with contact 61(7) and contact 53(8) aligns with contact 61(8). When the plug connector is inserted into receptacle connector 60 in a “down” position, as shown in FIG. 7B, each contact in the plug connector still properly aligns with a contact in the receptacle connector. The contacts align differently, however, as follows: contact 53(5) of the plug connector aligns with contact 61(1) of the receptacle connector, contact 53(6) aligns with contact 61(2), contact 53(7) aligns with contact 61(3) and contact 53(8) aligns with contact 61(4), while on the opposing surface, contact 53(1) aligns with contact 61(5), contact 53(2) aligns with contact 61(6), contact 53(3) aligns with contact 61(7) and contact 53(4) aligns with contact 61(8). Additionally, when plug connector 50 includes side ground contacts 53a, 53b, each side contact aligns with a corresponding side ground contact 61a, 61b from receptacle connector 60 in either of the two possible insertion orientations as shown in FIGS. 7A and 7B.

Thus, whether connector 50 is inserted into receptacle connector 60 in either the “up” or “down” position, proper electrical contact is made between the contacts in the plug connector and the receptacle connector. Embodiments of the invention further pertain to a receptacle connector that includes circuitry that switches the functionality of its pins based on the orientation of the plug connector. In some embodiments, a sensing circuit in the receptacle connector or the electronic device in which the receptacle connector is housed, can detect the orientation of the plug connector and set software and/or hardware switches to switch internal connections to the contacts in the receptacle connector and properly match the receptacle connector's contacts to the plug connector's contacts as appropriate. In some embodiments the orientation of the plug connector can be detected based on a physical orientation key (different from a polarization key in that an orientation key does not prevent the plug connector from being inserted into the receptacle connector in multiple orientations) that, depending on the orientation of the plug connector, engages or does not engage with a corresponding orientation contact in the receptacle connector. Circuitry connected to the orientation contact can then determine which of the two possible orientations the plug connector was inserted into the receptacle connector.

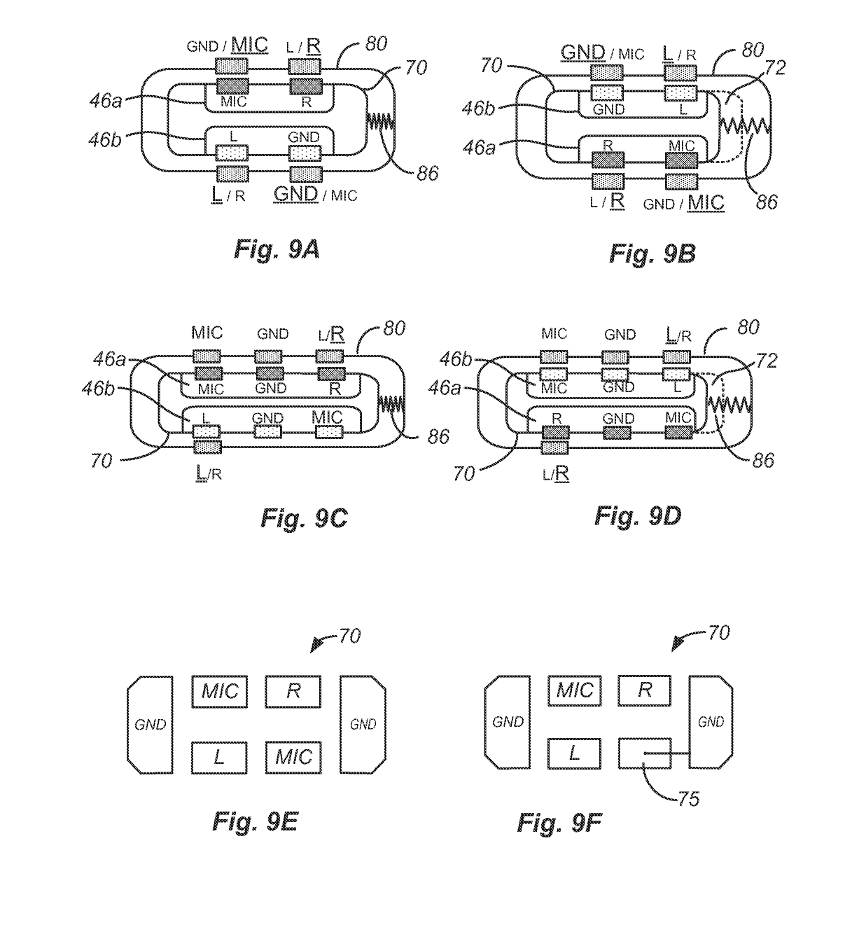

As an example, reference is now made to FIGS. 8A-8C, which show simplified top, bottom and side plan views of a plug connector 70 having an orientation key 72 according to an embodiment of the present invention along with FIGS. 9A and 9B, which are simplified schematic views of plug connector 70 inserted within a receptacle connector 80. Connector 70 includes contact regions 46a and 46b formed on opposing major surfaces of the connector that may contain any reasonable number of contacts. For example, in the particular embodiment shown in FIG. 9A, connector 70 is an audio plug connector and each of contact regions 46a and 46b include two contacts: a microphone contact and right audio contact in region 46a, and a left audio contact and a ground contact in region 46b. When connector 70 is mated with receptacle connector 80, orientation key 72 on the plug connector engages (or doesn't engage) with a corresponding orientation contact 86 within receptacle connector 80.

Circuitry operatively coupled to the receptacle connector can set software and/or hardware switches to properly match the receptacle connector's contacts to the contacts of plug connector 70. For example, a software switch can be used to switch the connector jack's contacts for left and right audio depending on the insertion orientation while a hardware switch can be used to switch the connector jacks microphone and ground contacts to match the contacts of connector 70. In other embodiments, both switches can be implemented in software or both switches can be implemented in hardware. A comparison of FIG. 9A to 9B illustrates the switching of the receptacle contacts depending on whether or not orientation contact 86 is engaged (FIG. 9B) or not engaged (FIG. 9A), where for ease of illustration, the labels of the switched contacts are underlined and depicted in a larger font.

As another example, connector 70 can be a six contact audio plug connector with each of contact regions 46a, 46b including three contacts as shown in FIGS. 9C-9D: a microphone contact, a first dedicated ground contact and a right audio contact are within region 46a; while a left audio contact, a second dedicated ground contact and a second dedicated microphone contact are located within region 46b. The first and second ground contacts and first and second microphone contacts align with ground and microphone contacts of the corresponding connector jack 80 regardless of the insertion orientation of connector 70. Thus, this embodiment can be carried out with a single switch that can be implemented in software or hardware to switch the connector jack's contacts for left and right audio depending on the insertion orientation which can be detected by orientation contact 86 within the receptacle connector.

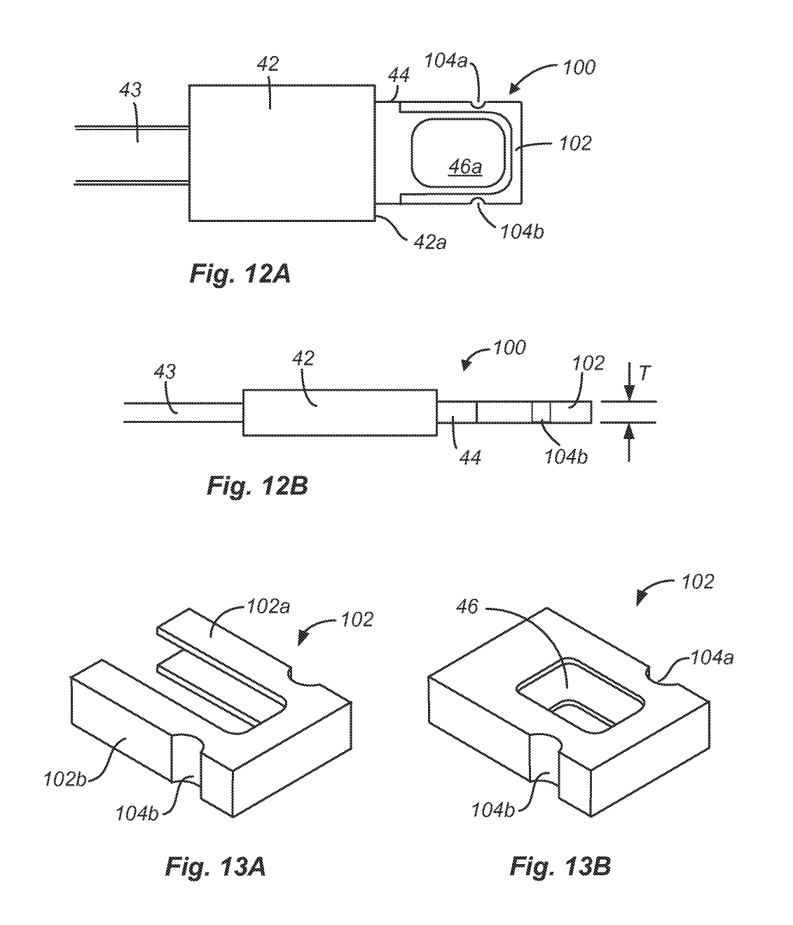

As shown in FIGS. 8A-8C, connector 70 can also include retention features 74a, 74b on opposing side surfaces of the connector. Retention features can operate to secure connector 70 in a corresponding receptacle connector as discussed below with respect to FIGS. 12A and 12B. Notably, in the embodiment shown in FIGS. 8A-8C, retention feature 74b and orientation key 72 combine to form a single extended cutout on the side 44d of connector 70. In other embodiments, the retention feature(s) and orientation key can be completely separated from each other and even be included on separate surfaces. For example, in one embodiment orientation key 72 can be located on one of major surfaces 44a or 44b while the retention features can be located on one or both of side surfaces 44c and 44d.

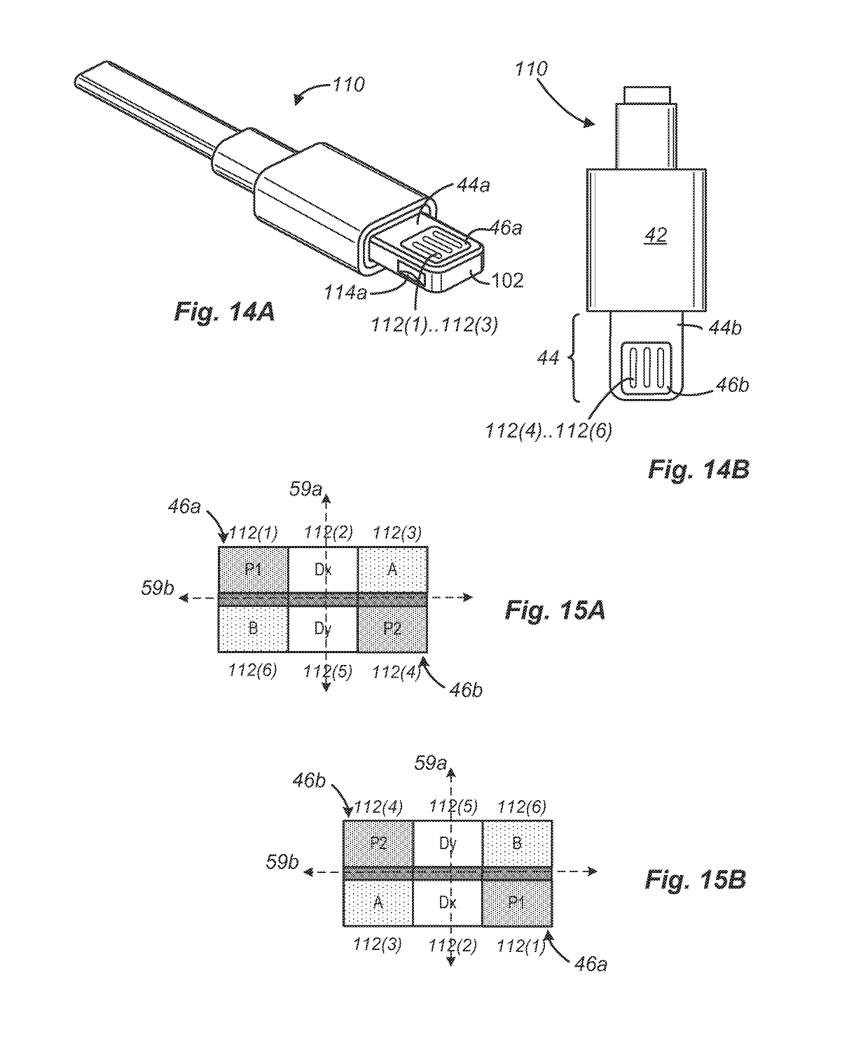

In other embodiments, the plug connector does not include an orientation key and the orientation of the connector can instead be detected by circuitry associated with the corresponding receptacle connector based on signals received over the contacts. As one example, various accessories such as headsets for cellular phones include a microphone and allow a user to perform basic functions such as setting earphone volume and answering and ending calls with the push of a button on the accessory. A single wire, serial control chip can be used to communicate with the host electronic device and implement this functionality. The chip is connected to the microphone contact (e.g., contact 112b shown in FIG. 14A) and, when the plug connector is inserted into the receptacle jack, can talk to appropriate circuitry in the jack connector or host device. Upon an insertion event, the host device sends an Acknowledgment signal to the serial control chip over the contact in the receptacle connector designated for the microphone and waits for a Response signal. If a Response signal is received, the contacts are aligned properly and audio and other signals can be transferred between the connectors. If no response is received, the host device flips the signals to correspond to the second possible orientation (i.e., flips the signals 180 degrees) and repeats the Acknowledgement/Response signal routine.

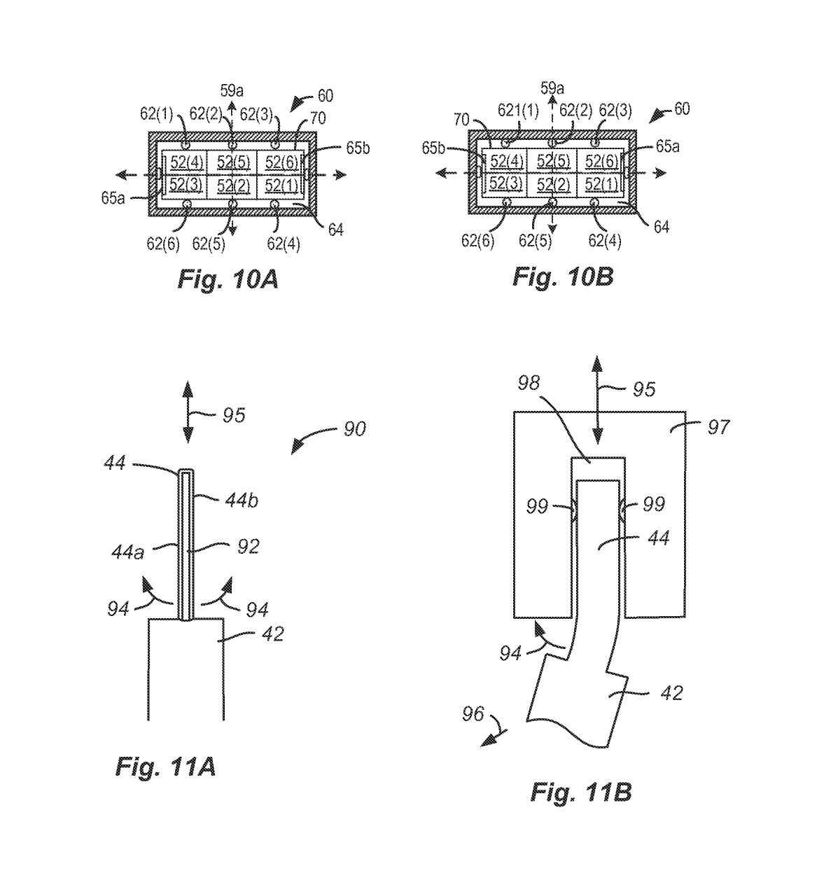

In the four contact embodiment of a plug connector 70 shown in FIG. 9E, left and right audio contacts are always in physically reversible positions while each of the other two contacts is designated as a microphone contact. In this embodiment, a physical orientation key in the plug connector, such as key 72, can be detected by an orientation contact or other appropriate mechanism in the receptacle connector to determine the orientation of the plug, and a hardware or software switch can set the receptacle connector contacts as appropriate for left and right audio to correspond to the plug connector contacts. In the embodiment of plug connector 70 shown in FIG. 9F, a contact 75 is connected to ground through, for example, a ground ring 102 (described with respect to FIGS. 10A-10B). When the connector is first plugged into a receptacle connector, circuitry associated with the receptacle connector or the electronic device in which the connector is housed detects the position of the grounded contact and switches the receptacle contacts to an appropriate orientation.

To facilitate the dual orientation feature of certain embodiments of the invention, contacts within contact regions 46a, 46b can be arranged such that similarly purposed contacts are located on opposite sides of the connector tab in a cater cornered arrangement. For example, referring back to FIG. 7A, contact 53(1) is in a cater cornered arrangement with contact 53(5) while contact 53(2) is in a cater cornered relationship with contact 53(6). Similarly purposed contacts are contacts that are designated to carry similar signals. Examples of similarly purposed contact pairs may include, first and second power contacts, left and right audio out contacts, first and second ground contacts, a pair of data differential contacts, and/or first and second digital contacts. Because of the symmetrical relationship between the contacts, such a cater cornered relationship ensures that for each pair of similarly purposed contacts in a cater cornered relationship, one of the similarly purposed contacts will be electrically connected to a contact in the receptacle connector that is either dedicated to the particular contact or can be readily switched to the particular contact. As an example, where contacts 53(1) and 53(5) are similarly purposed contacts that are dedicated to left and right audio out signals, respectively, when plug connector 50 is inserted into receptacle connector 60, one of the audio out contacts will be in electrical contact with receptacle contact 61(1) and the other of the audio out contacts will be in electrical contact with receptacle contact 61(5) regardless of whether the plug connector is mated with the receptacle connector in an “up” or “down” insertion orientation. Thus, both the receptacle contacts 61(1) and 61(5) can be audio contacts ensuring that they will be electrically coupled to an audio contact in the plug connector regardless of its insertion orientation.

While FIGS. 7A-7B depict a particular embodiment of the invention with an even number of contacts in each of contact regions 46a and 46b, some embodiments of the invention may include an odd number of contacts in each of regions 46a, 46b. In such embodiments, one of the contacts on each side of the plug connector is a central contact that is centered around bisecting line 59a and thus aligns with a centrally located receptacle contact in both the “up” and “down” positions. The central contacts are not in a cater cornered arrangement but are in a symmetrical arrangement and can be similarly purposed contacts according to some embodiments of the invention.

FIGS. 10A and 10B illustrate this aspect of certain embodiments of the invention and depict a plug connector 70 having three contacts 52(1) . . . 52(3) and 52(4) . . . 52(6) formed on the upper and lower surfaces of tab 44 of the plug connector, respectively. When the connector tab is inserted into a corresponding receptacle connector 80 in an “up” position, contacts 52(1) . . . 52(3) align with contacts 81(1) . . . 81(3) of the receptacle connector, respectively, and contacts 52(4) . . . 52(6) align with contacts 81(4) . . . 81(6), respectively. When the connector tab is inserted into receptacle connector 80 in a “down” position, contacts 52(4) . . . 52(6) align with contacts 81(1) . . . 81(3) of the receptacle connector, respectively, and contacts 52(1) . . . 52(3) align with contacts 81(4) . . . 81(6), respectively. In both orientations, plug connector contacts 52(2) and 52(5) align with one of the central receptacle contacts 81(2) or 81(5).

Plug connector 40 can be designed to be inserted into a matching receptacle connector, such as receptacle connector 80, along an insertion axis. In some embodiments of the invention, at least a portion of the plug connector is made from a flexible material so that the connector can readily bend off-axis. As an example, FIG. 11A shows a simplified side cross-sectional view of a connector 90 similar to connector 40 that is intended to be inserted into a receptacle connector along an insertion axis 95. Tab 44 of connector 90 includes a flexible carrier member 92 that extends the length of tab 44 along with contacts (not shown) formed on each of the opposing surfaces 44a, 44b of connector 90 that can flex with carrier member 92. As an example, the contacts can be part of a flex circuit that is bonded to flexible carrier member 92. Flexible carrier 92 and the flexible contacts allow tab 44 to be bent along a direction 94 into a deformed shape as shown in FIG. 11B when the connector is mated with a receptacle connector 97 (i.e., positioned with an insertion cavity 98 of the receptacle connector) and subject to strain by being pulled in a direction 96 that intersects insertion axis 95. As soon as the strain is relieved, tab 44 returns to its normal shape shown in FIG. 11A. In this manner, when connector 90 is pulled out of its receptacle connector by pulling at least partially sideways (e.g., along direction 96 as opposed to pulling along axis 95) on either body 42 or the cable (not shown) attached to body 42, plug connector 90 can bend and pull out of the receptacle connector rather than binding within it or eventually breaking.

In one particular embodiment, flexible carrier 92 is a sheet of superelastic material, such as nitinol (an alloy of nickel and titanium present in roughly equal amounts) and the flexible contacts are part of a flex circuit adhered to the superelastic sheet. Nitinol alloys exhibit elasticity some 10-30 times that of ordinary metal which enables it to flex under very high strain without breaking. The flex circuit may include, for example, metal contacts screen printed on a thin polyimide or PEEK (polyether ether ketone) layer. The flex circuit may be made from two separate pieces each of which is directly adhered to one side of the nitinol sheet or may be a single piece wrapped around the perimeter of the nitinol sheet or made into a sleeve that fits over the nitinol sheet.

Embodiments of the invention that include this flexibility characteristic are not limited to the use of any particular superelastic material and can instead use any material that deforms reversibly to very high strains and returns to its original shape when the load is removed without requiring a change of temperature to regain its original shape. Some embodiments of the invention may use flexible materials for carrier 92 that are not superelastic. For example, carrier 92 or tab 44 itself can be made from an elastomer or polyurethane in some embodiments.

When connector plug 90 is engaged with a corresponding receptacle connector and extracted at an angle to the insertion axis, more force is typically applied to the base of the connector than at its tip. To address this discrepancy, in some embodiments the flexibility of carrier 92 varies along the length of the carrier so that, for example, it is more flexible near the base portion or proximal end of the connector where it meets body 42 and less flexible near the distal end of the connector. Flexibility can be varied in this manner by, among other techniques, varying the materials along the length of the connector, varying the thickness of the flexible carrier along its length or varying the shape of the flexible carrier along its length or any combination of these approaches. For example, in one embodiment carrier 92 may include a superelastic sheet near its base and a polyurethane sheet near its distal end. The superelastic and polyurethane sheets may overlap and be adhered together in an area between the proximal and distal ends. In one particular embodiment, carrier 92 comprises two sheets of polyurethane near the distal end of tab 44 and a single sheet of nitinol near the base of tab 44 where the tab joins body 42. At a point approximately one third of the length of the connector from the distal end, the nitinol sheet is sandwiched between the two polyurethane sheets for a portion of the length.

Reference is now made to FIGS. 12A and 12B, which are simplified top and side views of a plug connector 100 according to another embodiment of the invention. Plug connector 100 includes many of the same features as plug connector 40 but further includes a cap 102, and first and second retention features 104a and 104b, respectively, near a distal tip of the connector. Cap 102 can be made from a metal or other conductive material and can extend from the distal tip of connector 100 along the side of the connector towards body 42 either fully or partially surrounding contacts formed in contact regions 46a and 46b in the X and Y directions. Cap 102 can be grounded in order to minimize interference that may otherwise occur on the contacts of connector 100. In one embodiment, cap 102 may be a u-shaped frame having a thickness that is equivalent to the thickness (T) of connector 100. In another embodiment, cap 102 covers the entirety of tab 44 except for contact regions 46a, 46b and thus defines the shape of tab 44. Cap 102 is sometimes referred to herein as a ground ring and those two terms are intended to be used interchangeably. Cap 102 can be formed in a variety of ways and in one embodiment can be die cast from a metal, such as stainless steel, that can be slid over and attached to the end of connector tab 44 thus partially or fully surrounding contact regions 46a and 46b at the tip and sides of the connector.

FIGS. 13A and 13B show two different embodiments of cap 102. In FIG. 13A, cap 102 is a u-shaped frame that can be attached to or slid over the end of the connector. Cap 102 includes side portions 102a, 102b that may have varying lengths in different embodiments. In some embodiments sides 102a, 102b extend past contact regions 46a, 46b all the way to the body 42 of the connector. In other embodiments the sides may extend past contact regions 46a, 46b but not all the way to body 42 (as shown in FIG. 12A); may extend exactly to the end of contact regions 46a, 46b or may be relatively short and extend only partially along the length of the contact regions. Contact regions 46a, 46b lie between the opposing sides 102a, 102b. In still other embodiments, cap or ground ring 102 defines the exterior shape of tab 44 completely surrounding the contact regions 46 at the outer surfaces of the connector as shown in FIG. 13B.

Referring back to FIGS. 12A and 12B, retention features 104a, 104b are formed on the opposing sides of connector 100 and are part of a retention system that includes one or more features on the plug connector that are adapted to engage with one or more features on the corresponding receptacle connector to secure the connectors together when the plug connector is inserted into the receptacle connector. In the illustrated embodiment, retention features 104a, 104b are semi-circular indentations in the side surfaces of tab 44 that extend from surface 44a to surface 44b The retention features may be widely varied and may include angled indentations or notches, pockets that are formed only at the side surfaces and do not extend to either of the surfaces 44a, 44b upon which contact regions 46a, 46b are formed, or other recessed regions. The retention features are adapted to engage with a retention mechanism on the receptacle connector that can be similarly widely varied. The retention mechanism(s) may be, for example, one or more springs that includes a tip or surface that fits within indentations 104a, 104b, one or more spring loaded detents, or similar latching mechanisms. The retention system, including retention features 104a, 104b and the corresponding retention mechanism on the receptacle connector, can be designed to provide specific insertion and extraction forces such that the retention force required to insert the plug connector into the receptacle connector is higher than the extraction force required to remove the plug connector from the receptacle connector.

While retention features 104a, 104b are shown in FIGS. 12A and 12B as having a female mating characteristic and the retention mechanism was described above as having a male characteristic that is moved into the retention features 104a, 104b, in other embodiments these roles may differ. For example, in one embodiment, retention features 104a, 104b may be spring loaded projections that engage with a female retention mechanism on the receptacle connector. In still other embodiments, one of features 104a, 104b may be male-oriented while the other of features 104a, 104b is female-oriented. In other embodiments, other retention mechanisms can be used such as mechanical or magnetic latches or orthogonal insertion mechanisms. Additionally, while retention features 104a and 104b are shown in FIGS. 12A and 12B as being formed in metal cap 102, in embodiments of the invention that do not include a metal cap or ground ring, the retention features can be formed in whatever structure or material makes up tab 44.

Retention features 104a, 104b can also be located at a variety of positions along connector 100 including along the side surfaces of tab 44 and/or top and bottom surfaces of tab 44. In some embodiments, retention features 104a, 104b can be located on a front surface 42a of body 42 and adapted to engage with a retention mechanism located on a front exterior surface of the receptacle connector. In the embodiment illustrated in FIGS. 12A and 12B, retention features 104a, 104b are positioned within the last third of the length of tab 44. The inventors have determined that positioning the retention features and corresponding latching mechanism in the receptacle connector near the end of the plug connector helps to better secure the connector sideways when it is in an engaged position within the receptacle connector.

The description of various embodiments of the invention set forth above with respect to FIGS. 3A-13B describes a number of different features, aspects and variations of different embodiments of the invention. To gain a further understanding of the invention, examples of several specific data connectors having different numbers of contacts are discussed below that include some or all of the features already mentioned as well as additional features. The various embodiments discussed below include many features in common with embodiments already discussed and with each other. As a matter of convenience such common features are often, but not always, referred to with the same reference number. Additionally, in the discussion below, reference to a connector having a specific number of contacts generally refers to the number of contacts on the opposing major surfaces of the connector and does not include any ground or other contacts formed on the tip and/or sides of the connector.

FIGS. 14A and 14B are simplified top perspective and bottom plan views of a plug connector 110 according to an embodiment of the invention. Connector 110 includes many of the same features as plug connector 100 and has three contacts 112(1) . . . 112(3) positioned within contact region 46a and an additional three contacts 112(4) . . . 112(6) positioned within contact region 46b on the opposing surface of tab 44. The contacts can be made from a copper, nickel, brass, a metal alloy or any other appropriate conductive material. Spacing is consistent between each of the contacts on the front and back sides and between the contacts and the edges of the connector providing 180 degree symmetry so that plug connector 300 can be inserted into a corresponding receptacle connector in either of two orientations as discussed above.

The structure and general shape of tab 44 is defined by ground ring 102 that extends from a distal tip of the connector towards the outer shell forming an outer periphery of tab 44 and surrounding contacts 112(1) . . . 112(6) in the x-plane and y-plane. Ground ring 102 can be made from any appropriate metal or other conductive material and in one embodiment is stainless steel plated with copper and/or nickel. Two indentations or pockets 112a and 112b are formed in ground ring 102 and located on opposing sides of the tab near its distal end as with connector 150. Ground contacts can be formed in each of pockets 112a, 112b. In one particular embodiment, tab 44 of connector 300 has a width, X, of 4.0 mm; a thickness, Y, of 1.5 mm; and a insertion depth, Z, of 5.0 mm. It is understood that the dimensions of connector 110 as well as the number of contacts may vary in different embodiments.

When connector 110 is properly engaged with a receptacle connector, each of contacts 112(1) . . . 112(6) is in electrical contact with a corresponding contact in the corresponding receptacle connector. Tab 44 has a 180 degree symmetrical, double orientation design which enables the connector to be inserted into a receptacle connector in either a first orientation where surface 44a is facing up or a second orientation where surface 44b is facing up as discussed above. Circuitry within the host device in which the receptacle connector is incorporated can switch the receptacle connector contacts to match the orientation of connector 110.

In some embodiments, the particular signal/function that each of contacts 112(1) . . . 112(6) is dedicated for may vary depending on the device that connector 110 is part of. On the host side, switching circuitry associated with the host is able to multiplex different circuitry to match the different signals as required. To facilitate the switching and simplify the required switching circuitry on the host side associated with the orientation agnostic feature of connector 110, contacts in a cater cornered relationship can be similarly purposed contacts as can the central contacts. For example, in an embodiment of connector 110 shown in FIG. 15A, contacts 112(3) and 112(6) are similarly purposed dedicated for a first pair of data signals A and B, respectively; while central contacts 112(2), 112(5) are similarly purposed contacts dedicated for a second pair of data signals Dx and Dy, respectively. Regardless of whether plug connector 100 is mated with its corresponding receptacle connectors in an “up” position (FIG. 15A) or a “down” position (FIG. 15B, data contacts A and B will always align with either the upper right or lower left receptacle connector contacts while data contacts Dx and Dy will always align with the central receptacle connector contacts.

To further illustrate, several specific examples of accessories that employ contacts 112(1) . . . 112(6) for different purposes are provided below in Table 1 where connector 110 is associated with one the following categories of accessories: (1) a self-powered accessory, such as a clock radio or similar docking station; (2) a host powered accessory; (3) a wired headset; (4) a headphone adapter; and (5) a charge/sync cable.

TABLE 1

| | Self- | Host- | | | Charge/ |
|---|---|---|---|---|---|
| | Powered | Powered | Wired | Headphone | Sync |
| Contact | Accessory | Accessory | Headset | Adapter | Cable |
| P1: | Pwr Out | Acc In | — | — | Pwr Out |
| 112(1) | (5 V) | (3.3 V) | | | (5 V) |
| P2: | ID/Audio | ID/Audio | ID | ID | ID |
| 112(4) | Ret | Ret | | | |
| Dx: | D⁺/ | D⁺/ | Audio | Audio | D⁺ |
| 112(2) | Audio | Audio | Left | Left | |
| | Left | Left | | | |
| Dy: | D⁻/ | D⁻/ | Audio | Audio | D⁻ |
| 112(5) | Audio | Audio | Right | Right | |
| | Right | Right | | | |
| A: 112(3) | RXD | RXD | MIC | A_Ret/MIC | — |
| B: 112(6) | TXD | TXD | Audio_Ret | MIC/A_Ret | — |

As shown in Table 1, the data contacts at similarly-purposed locations 112(2), 112(5) and 112(3), 112(6) can be used to transmit analog or digital data signals between connector 110 and a host device according to several different communication protocols depending on the function and purpose of an accessory that connector 110 is part of. For example, contacts 112(2), 112(5) can be used to transmit analog audio left and right signals or transmit differential data signals (D⁺/D⁻), while contacts 112(3), 112(6) can be used to transmit serial transmit/receive signals or transmit analog microphone and audio-return signals. In order for the host device to be able to process and act upon the signals, the host first needs to determine what communication protocol or signal format a given connector 110 provides at each contact. The host can do this, for example, by detecting the insertion orientation of connector 110 and receiving instructions from the accessory associated with connector 110 that indicate the type of signal(s) the particular accessory will use each contact for. As one example, in a self-powered accessory and a charger/sync cable, contact 112(1) may provide a Power Out signal to charge the host device. The host can monitor the voltage level over its two contacts that, depending on the insertion orientation of connector 110, could align with contact 112(1) to detect the power signal and determine the orientation of the connector. As another example, for headset, headphone adapter and host-powered accessories that do not provide power out, the insertion orientation of connector 110 can be detected based on detecting the presence of the ID signal on one of the two contacts that, depending on the insertion orientation of connector 110, could align with contact 112(4). In either case, once the location of contact 112(4) is confirmed, contact 112(4)may be used to transmit an ID signal that informs the host of the communication protocols used over each of the contacts using a predetermined data structure that can be transmitted over one or more of the contacts. In one embodiment, the data structure specifies what each of contacts 112(2), 112(3), 112(5) and 112(6) is used for by the particular accessory.

Once the orientation is detected and the purpose of the various contacts in connector 110 has been communicated to the host, the contacts in the receptacle connector can be switched by the host to connect circuitry appropriate for the given communication protocol as set forth in Table 1 above. Thus, for a charge/sync cable in which central contacts 112(2), 112(5) are a pair of differential data contacts, such as a pair of USB 2.0 data contacts, the corresponding receptacle connector contacts are each switched to matching circuitry appropriate for communication via USB 2.0 protocol with the polarity of the matching contacts based on the detected insertion orientation. Similarly, for a wired headset or a headphone adapter in which contacts 112(2), 112(5) are for left and right audio, respectively, and contacts 112(3), 112(6) are for Microphone and Audio Return signals, respectively, the corresponding receptacle connector contacts are each switched to circuitry appropriate for these analog signals. For self-powered and host-powered accessories, data contacts A and B can be dedicated to a pair of serial transmit/receive data signals, such as UART signals.

Also, some self-powered and host-powered accessories may use contacts Dx and Dy for differential data signals while in other accessories may use contacts Dx and Dy for left and right audio signals.

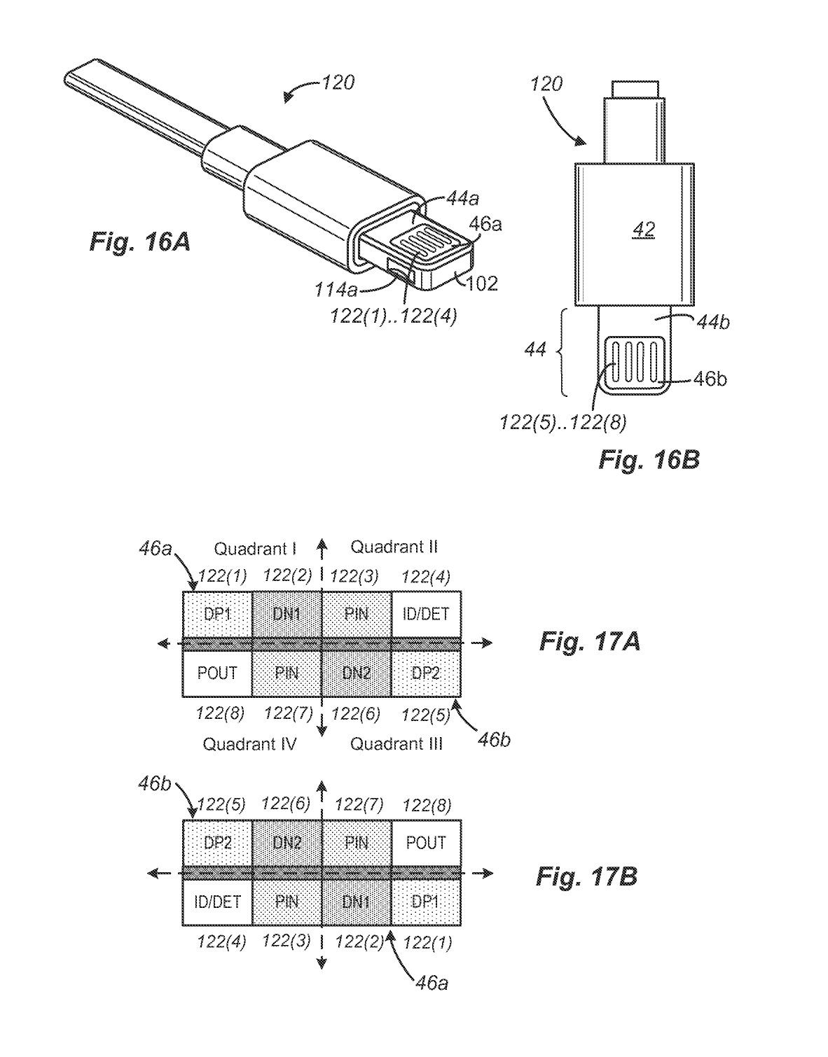

FIGS. 16A and 16B are simplified top perspective and bottom plan views of a plug connector 120 according to another embodiment of the invention. Connector 120 is similar to connector 110 except that connector 120 includes four contacts 122(1) . . . 122(4) positioned within contact region 46a and an additional four contacts 122(5) . . . 122(8) positioned within contact region 46b on the opposing surface of tab 44. In one particular embodiment, tab 44 of connector 120 has a width, X, of 5.0 mm; a thickness, Y, of 1.5 mm; and a insertion depth, Z, of 5.6 mm. It is understood that the dimensions of connector 110 as well as the number of contacts may vary in different embodiments.

The particular signal/function that each of contacts 122(1) . . . 122(8) is dedicated for may vary depending on the device that connector 120 is part of. On the host side, switching circuitry associated with the host is able to multiplex different circuitry to match the different signals as required. As was described with respect to connector 110, to facilitate the switching and simplify the required switching circuitry on the host side associated with the orientation agnostic feature of connector 110, some or all of the contacts in a cater cornered relationship can be similarly purposed contacts. For example, in an embodiment of connector 110 shown in FIG. 17A, contacts 122(1) and 122(5) are similarly purposed dedicated for data signals DP1 and DP2, respectively; contacts 122(2), 122(6) are similarly purposed contacts dedicated for data signals DN1 and DN2, respectively; and contacts 122(3) and 122(7) are each dedicated to power (PIN). Regardless of whether plug connector 100 is mated with its corresponding receptacle connectors in an “up” position (FIG. 17A) or a “down” position (FIG. 17B), data contacts DP1 and DP2 will always align with either the upper left or lower right receptacle connector contacts; data contacts DN1 and DN2 will always align with the upper receptacle connector contact second from the left or the lower receptacle connector contact second from the right; and power contacts 122(3), 122(7) will always align with the upper receptacle connector contact second from the right or the lower receptacle connector contact second from the left.

Having four data contacts allows an accessory to accommodate two of the following three communication interfaces: USB 2.0, Mikey Bus or a universal asynchronous receiver/transmitter (UART) interface. In order to further simplify the switching circuitry associated with the host, in some embodiments connector 120 does not include contacts for analog audio signals and instead implements audio through one of the digital signal interfaces, such as USB. Several specific examples of accessories that employ contacts 122(1) . . . 122(8) for different purposes are provided below in Table 2 where connector 120 is associated with one the following categories of accessories: (1) a self-powered accessory, (2) a host powered accessory; (3) a headset; and (4) a charge/sync cable.

TABLE 2

| | Self- | Host- | | Charge/ |
|---|---|---|---|---|
| | Powered | Powered | Wired | Sync |
| Contact | Accessory | Accessory | Headset | Cable |
| P1: 122(3) | Power | — | — | Power |
| | (5 V) | | | (5 V) |
| P2: 122(7) | Power | — | — | Power |
| | (5 V) | | | (5 V) |
| DP1: 122(1) | USB D⁺ | USB D⁺ | Mikey Bus⁺ | USB D⁺ |
| DP2: 122(5) | USB D⁻ | USB D⁻ | Mikey Bus⁻ | USB D⁻ |
| DN1: 122(2) | UART Rx | UART Rx | | — |
| DN2: 122(6) | UART Tx | UART Tx | | — |
| ID: 122(4) | AUTH | AUTH | AUTH | AUTH |
| POUT: 122(8) | Acc Pwr | Acc Pwr | Acc Pwr | — |
| | (3.3 V) | (3.3 V) | (3.3 V) | |

As discussed above, a host can detect the insertion orientation of connector 120 by detecting either a power signal or an ID signal on either contact 122(3) or 123(7). Once the location of the ID contact is confirmed, the ID contact may be used to transmit an ID signal that can authenticate the accessory and inform the host of the communication protocols used over each of the data contacts according to a predetermined data structure. In one embodiment, the data structure specifies what communication protocol each of contacts 122(1), 122(2), 122(5) and 122(6) is used for by the particular accessory.

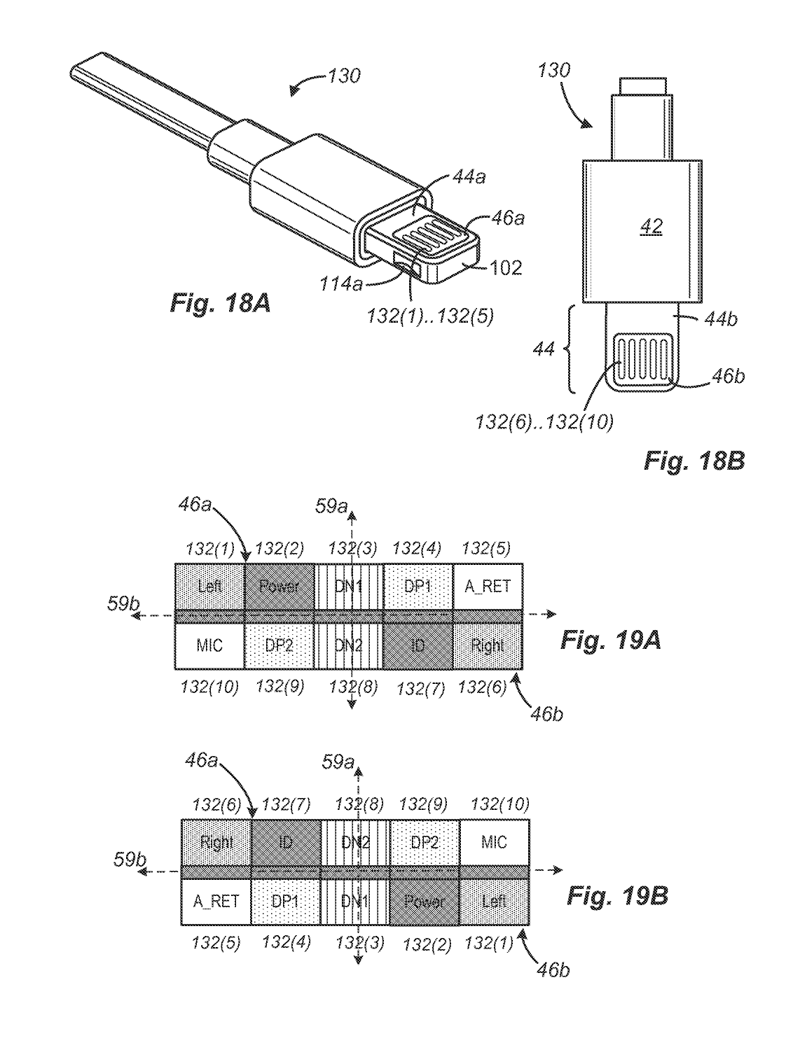

FIGS. 18A and 18B are simplified top perspective and bottom plan views of a plug connector 130 according to an embodiment of the invention. Connector 130 is similar to connector 110 except that connector 130 includes five contacts 132(1) . . . 132(5) positioned within contact region 46a and an additional five contacts 132(6) . . . 132(10) positioned within contact region 46b on the opposing surface of tab 44. In one particular embodiment, tab 44 of connector 120 has a width, X, of 5.9 mm; a thickness, Y, of 1.5 mm; and a insertion depth, Z, of 5.6 mm. It is understood that the dimensions of connector 110 as well as the number of contacts may vary in different embodiments.

The particular signal/function that each of contacts 132(1) . . . 132(10) is dedicated for may vary depending on the device that connector 130 is part of. On the host side, switching circuitry associated with the host is able to multiplex different circuitry to match the different signals as required. As was described with respect to connector 110, to facilitate the switching and simplify the required switching circuitry on the host side associated with the orientation agnostic feature of connector 130, some or all of the contacts in a cater cornered relationship can be similarly purposed contacts. For example, in an embodiment of connector 130 shown in FIG. 19A, contacts 132(4) and 132(9) are similarly purposed dedicated for data signals DP1 and DP2, respectively; contacts 132(3), 132(8) are similarly purposed contacts dedicated for data signals DN1 and DN2, respectively; and contacts 132(5), 132(10) and contacts 132(1), 132(6) are similarly proposed contacts each dedicated to analog signals. Regardless of whether plug connector 100 is mated with its corresponding receptacle connectors in an “up” position (FIG. 19A) or a “down” position (FIG. 19B), data contacts DP1 and DP2 will always align with either the same pair of receptacle connector contacts; data contacts DN1 and DN2 will always align with the central receptacle connector contacts; and each pair of analog contacts will always align with the same respective pair of receptacle connector contacts at the corners of the receptacle connector.

Having four data contacts allows an accessory to accommodate two of the following three communication interfaces: USB 2.0, Mikey Bus or a universal asynchronous receiver/transmitter (UART) interface. In order to further simplify the switching circuitry associated with the host, in some embodiments connector 130 does not include contacts for analog audio signals and instead implements audio through one of the digital signal interfaces, such as USB. Several specific examples of accessories that employ contacts 132(1) . . . 132(10) for different purposes are provided below in Table 3 and Table 4 where connector 130 is associated with one the following categories of accessories: (1) a self-powered accessory; (2) a host powered accessory; (3) a headset; and (4) a charge/sync cable; (5) a wired handset; (6) a headset adapter; (7) an audio/video cable; and (8) an audio accessory.

TABLE 3

| | | | Wired | |
|---|---|---|---|---|
| | Self- | Host- | Headset/ | Charge/ |
| | Powered | Powered | Headset | Sync |
| Contact | Accessory | Accessory | Adapter | Cable |
| PIN: 132(2) | Power | Power | Power | Power |
| | In | Out | Out | In |
| ID: 132(7) | ID/ | ID/ | ID/ | ID/ |
| | Detect | Detect | Detect | Detect |
| DN1: 132(3) | USB D⁻ | USB D⁻ | Mikey | USB D⁻ |
| | | | Bus⁻ | |
| DP1: 132(4) | USB D⁺ | USB D⁺ | Mikey | USB D⁺ |
| | | | Bus⁺ | |
| DN2: 132(8) | UART Rx | UART Rx | — | — |
| DP2: 132(9) | UART Tx | UART Tx | — | — |
| LEFT: 132(6) | — | — | — | — |
| RIGHT: 132(8) | — | — | — | — |
| MIC: 132(10) | — | — | — | — |
| A-RET: 132(5) | — | — | — | — |

TABLE 4

| | Wired | Headset | A/V | Audio |
|---|---|---|---|---|
| Contact | Headset | Adapter | Cable | Accessory |
| PIN: 132(2) | — | — | Power In | Power In |
| ID: 132(7) | ID/ | ID/ | ID/ | ID/ |
| | Detect | Detect | Detect | Detect |
| DN1: 132(3) | Mikey | Mikey | USB D⁻ | USB D⁻ |
| | Bus⁻ | Bus⁻ | | |
| DP1: 132(4) | Mikey | Mikey | USB D⁺ | USB D⁺ |
| | Bus⁺ | Bus⁺ | | |
| DN2: 132(8) | — | — | UART Rx | UART Rx |
| DP2: 132(9) | — | — | UART Tx | UART Tx |
| LEFT: 132(6) | Audio L | Audio L | Audio L | Audio L |
| RIGHT: 132(8) | Audio R | Audio R | Audio R | Audio R |
| MIC: 132(10) | MIC Bias/ | MIC Bias/ | Comp | Power Out |
| | Mikey Bus | Mikey Bus | | |
| | Power | Power | | |
| A-RET: 132(5) | Audio | Audio | Audio | Audio |
| | Return | Return | Return | Return |

As discussed above, a host can detect the insertion orientation of connector 130 by detecting either a power signal or an ID signal on either contact 132(2) or 132(7). Once the location of the ID contact is confirmed, the ID contact may be used to transmit an ID signal that informs the host of the communication protocols used over each of the contacts using a predetermined data structure that can be transmitted over one or more of the contacts. In one embodiment, the data structure specifies what each of contacts 132(2), 132(3), 132(8) and 132(9) is used for by the particular accessory.

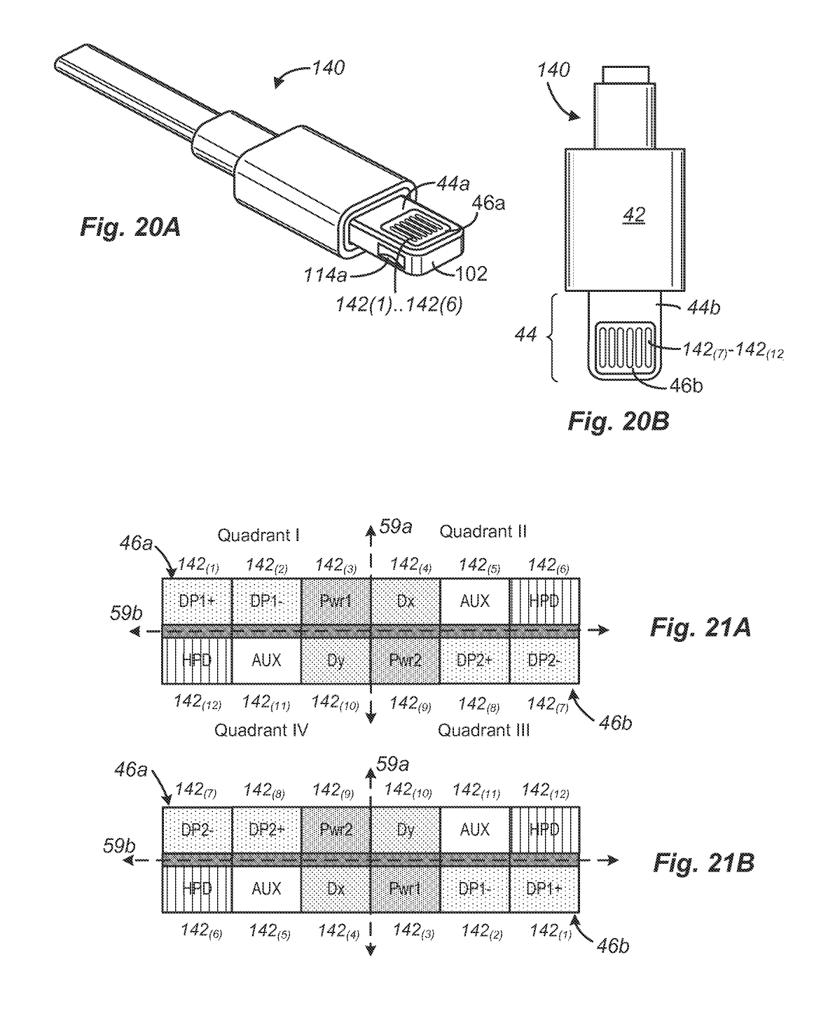

FIGS. 20A and 20B are simplified top perspective and bottom plan views of a plug connector 140 according to an embodiment of the invention. Connector 140 is similar to connector 110 except that it includes six contacts positioned within each of contact regions 46a and 46b. As was described with respect to connector 110, the particular signal/function that each of contacts 142(1) . . . 142(12) is dedicated for may vary depending on the device that connector 140 is part of. Switching circuitry on the host side is able to multiplex different circuitry to match the different signals as required. To facilitate the switching and simplify the required switching circuitry associated with the orientation agnostic feature of connector 140, some or all of the contacts in a cater cornered relationship can be similarly purposed contacts. For example, in an embodiment of connector 140 shown in FIG. 20A, a pair of differential data contacts 142(1), 142(2) are spaced in a cater cornered relationship with a second pair of differential data contacts 142(7), 142(8); data contacts 142(4), 142(10) are similarly purposed contacts dedicated for data signals Dx and Dy, respectively; contacts 142(3) and 142(9) are each dedicated to power; contacts 142(5), 142(11) are dedicated to a display port auxiliary signal; and contacts 142(6), 142(12) are dedicated to a display port hot plug detect signal.

In one embodiment, having twelve contacts allows connector 140 to accommodate two lanes of display port video along with display port hot plug detect (HPD) and axillary (Aux) signals and/or other communication interfaces such as USB 2.0, Mikey Bus or a universal asynchronous receiver/transmitter (UART) interface. In order to further simplify the switching circuitry associated with the host, in some embodiments connector 120 does not include contacts for analog audio signals and instead implements audio through one of the digital signal interfaces, such as USB. In another embodiment, instead of using two lanes of display port video, the extra two pairs of data contacts can be used for USB 3.0 data signals (a first Superspeed transmitter differential pair and a second Superspeed receiver differential pair) while the contacts dedicated for display port HPD and Aux can instead be dedicated to analog audio signals including left and right audio channels along with a microphone signal and an audio return. In still another embodiment, the four pairs of data contacts used for display port signals in connector 140 can instead be dedicated to signals that accommodate the Thunderbolt communication interface. For example, contacts 142(1) and 142(2) may carry differential data signals HighSpeed Transmit 0 (positive) and HighSpeed Transmit 0 (negative); contacts 142(5), 142(6) may carry differential data signals HighSpeed Receive 0 (positive) and HighSpeed Receive 0 (negative); contacts 142(7), 142(7) may carry differential data signals HighSpeed Transmit 1 (positive) and HighSpeed Transmit 1 (negative); and contacts 142(11), 142(12) may carry differential data signals HighSpeed Receive 1 (positive) and HighSpeed Receive 1 (negative).

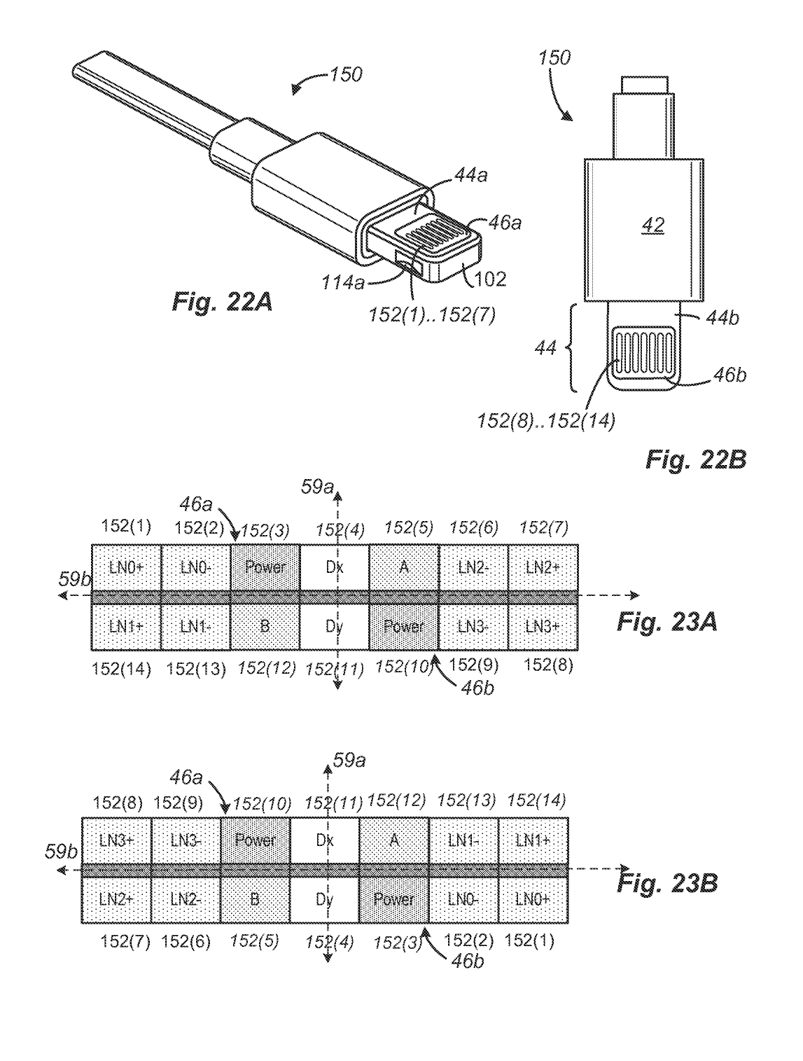

FIGS. 22A and 22B are simplified top perspective and bottom plan views of a plug connector 150 according to an embodiment of the invention. Connector 150 is similar to connector 110 discussed with respect to FIGS. 14A-15B except that it includes seven contacts positioned within each of contact regions 46a and 46b. The additional contacts enable connector 150 to accommodate four lanes of display port video and/or other communication interfaces such as USB 2.0, Mikey Bus or a universal asynchronous receiver/transmitter (UART) interface.

As was described with respect to connector 110, the particular signal/function that each of contacts 152(1) . . . 152(14) is dedicated for may vary depending on the device that connector 140 is part of. Switching circuitry on the host side is able to multiplex different circuitry to match the different signals as required. To facilitate the switching and simplify the required switching circuitry associated with the orientation agnostic feature of connector 150, some or all of the contacts in a cater cornered relationship can be similarly purposed contacts. For example, in an embodiment of connector 130 shown in FIG. 21A, two data contacts 152(1), 152(2) dedicated to a first lane of display port video signals are located at surface 44a at one end of connector 140 and positioned in a cater cornered relationship with data contacts 152(8), 152(9) dedicated to a third lane of display port video signals located at surface 44b at the opposite end of connector 150; while two data contacts 152(6), 152(7) dedicated to a second lane of display port video signals are located at surface 44a at one end of connector 150 and positioned in a cater cornered relationship with data contacts 152(13) and 152(14) dedicated to a fourth lane of display port video signals located at surface 44b. The inner six data contacts—contacts 152(3)-152(5) and contacts 152(10)-152(12) can be dedicated towards the same signals as those described in relation to FIGS. 15A and 15B. Thus, connector 150 can be used for all the same accessories as discussed with respect to connector 110 along with accessories that support four lanes of display port video data in which case one or more of the inner six contacts can be used for a display port hot plug detect signal and another for a display port auxiliary signal.

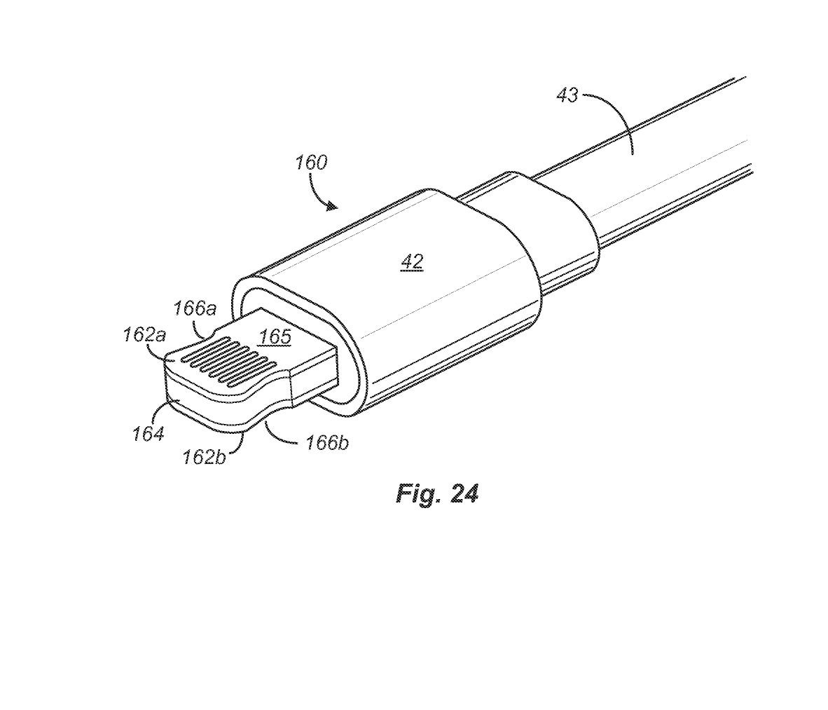

FIG. 24 is a simplified perspective view of a connector plug 160 according to another embodiment of the invention in which a ground ring is not employed. Instead, connector 160 is made from two printed circuit boards 162a, 162b sandwiched around a structural conductive member 164, such as a brass plate. A tab portion 165 extends out of body 42 and can have the same form factor as tab 44 of any of connectors 110, 120, 130, 140 or 150 discussed above including the same number of contacts (for convenience, FIG. 24 shows six on an upper surface of connector 160 and six on a lower surface) spaced the same distance from the edges of the connector at the same spacing enabling a given plug connector 160 to be operatively coupled to the same receptacle connectors such as one of plug connectors 110, 120, 130, 140 or 150 that includes the same number of contacts.

Connector 160 does not include a ground ring similar to ground ring 102, however. Instead, indentations 166a, 166b formed on opposing sides of conductive member 164 match generally the size and contour of pockets 114a, 114b giving the tab portion of connector 160 a bread loaf shape when viewed from above or below. Indentations 166a, 166b provide the connector the same comfortable click/lock feeling achieved by connector 140 when it is inserted and removed from a receptacle connector. Also, when mated with a receptacle connector, conductive member 164 receives a ground connection via the retention clips in the receptacle connector.

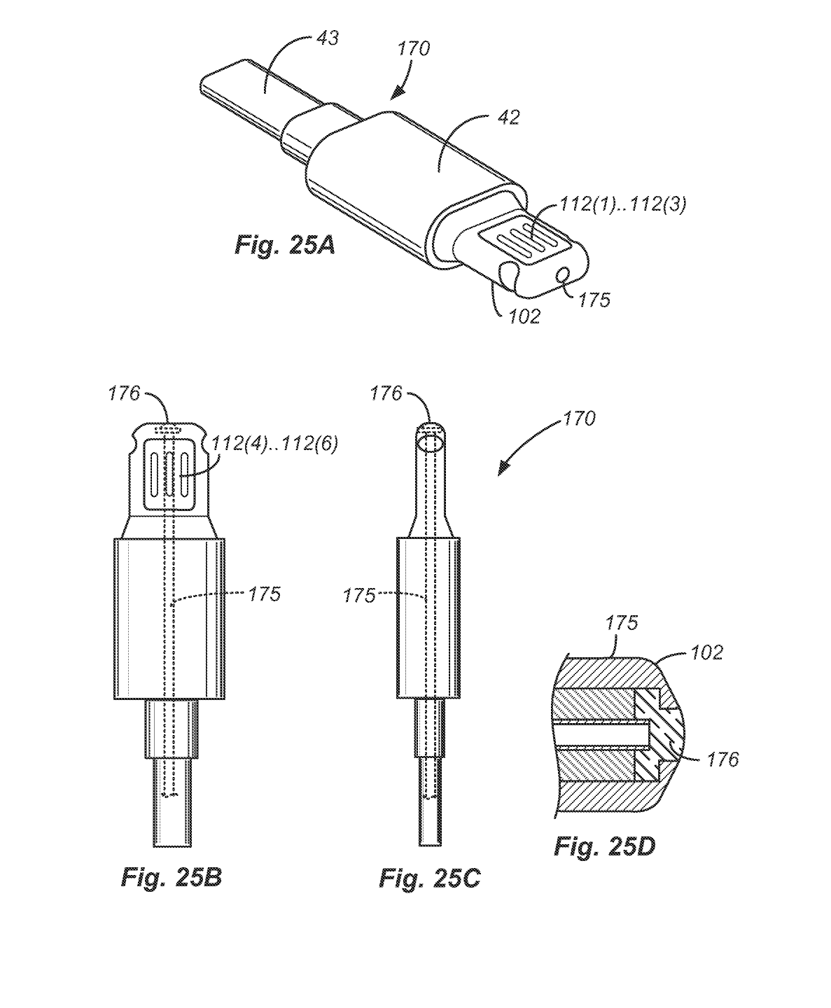

Any of the connectors discussed herein can be modified to include one or more fiber optic cables that extend through the connector and can be operatively coupled to receive or transmit optical data signals between a mating connector jack. As an example, FIGS. 25A-25D illustrate one example of a connector 170 having six contacts as well as a fiber optic cable 175 that runs through the center of the connector. Fiber optic cable 175 allows for high data rate transmissions and can be used for USB 4.0 compatibility (e.g., 10 GB/second data transfer).

As shown in FIG. 25D, which is an expanded view of the distal end of connector 170, fiber optic cable 175 terminates at a lens 176 positioned at the distal end of the connector and secured in place by ground ring 102. Lens 176 can be made from a chemically strengthened aluminosilicate glass or a similar material that is highly resistant to scratching and is flush with the external surface of ground ring 102 to prevent debris build-up and abstraction of light.

Embodiments of the invention are suitable for a multiplicity of electronic devices, including any device that receives or transmits audio, video or data signals among others. In some instances, embodiments of the invention are particularly well suited for portable electronic media devices because of their potentially small form factor. As used herein, an electronic media device includes any device with at least one electronic component that may be used to present human-perceivable media. Such devices may include, for example, portable music players (e.g., MP3 devices and Apple's iPod devices), portable video players (e.g., portable DVD players), cellular telephones (e.g., smart telephones such as Apple's iPhone devices), video cameras, digital still cameras, projection systems (e.g., holographic projection systems), gaming systems, PDAs, desktop computers, as well as tablet (e.g., Apple's iPad devices), laptop or other mobile computers. Some of these devices may be configured to provide audio, video or other data or sensory output.

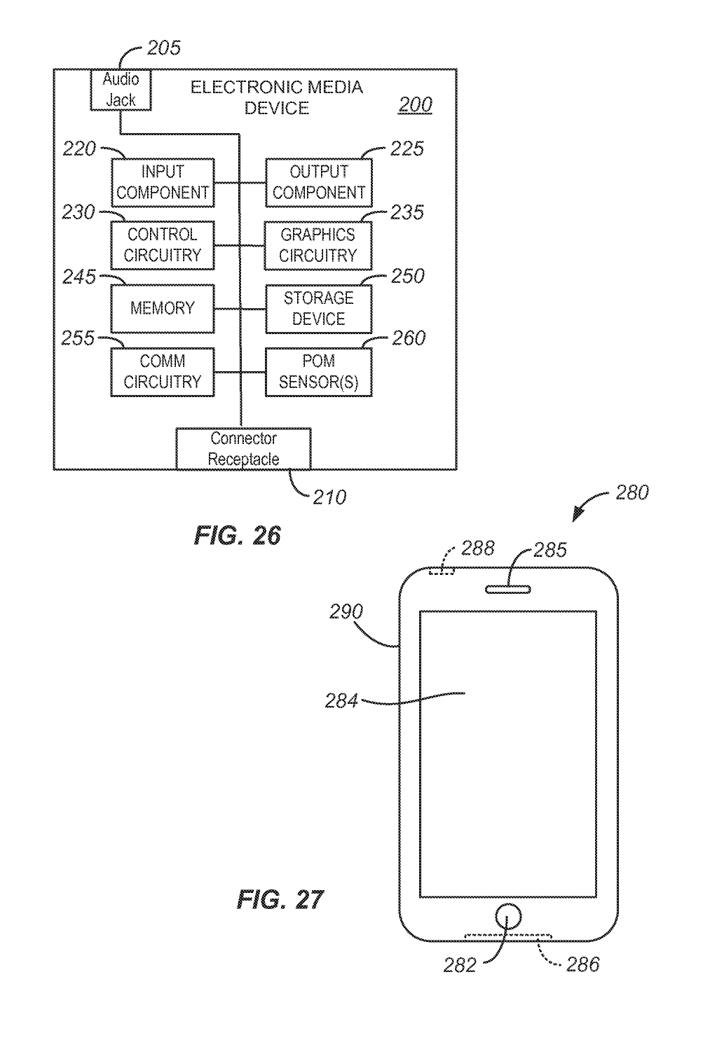

FIG. 26 is a simplified illustrative block diagram representing an electronic media device 200 that includes an audio plug receptacle 205 according to embodiments of the present. Electronic media device 200 may also include, among other components, connector receptacle 210, one or more user input components 220, one or more output components 225, control circuitry 230, graphics circuitry 235, a bus 240, a memory 245, a storage device 250, communications circuitry 255 and POM (position, orientation or movement sensor) sensors 260. Control circuitry 230 may communicate with the other components of electronic media device 200 (e.g., via bus 240) to control the operation of electronic media device 200. In some embodiments, control circuitry 230 may execute instructions stored in a memory 245. Control circuitry 230 may also be operative to control the performance of electronic media device 200. Control circuitry 230 may include, for example, a processor, a microcontroller and a bus (e.g., for sending instructions to the other components of electronic media device 200). In some embodiments, control circuitry 230 may also drive the display and process inputs received from input component 220.

Memory 245 may include one or more different types of memory that may be used to perform device functions. For example, memory 245 may include cache, flash memory, ROM, RAM and hybrid types of memory. Memory 245 may also store firmware for the device and its applications (e.g., operating system, user interface functions and processor functions). Storage device 250 may include one or more suitable storage mediums or mechanisms, such as a magnetic hard drive, flash drive, tape drive, optical drive, permanent memory (such as ROM), semi-permanent memory (such as RAM) or cache. Storage device 250 may be used for storing media (e.g., audio and video files), text, pictures, graphics, advertising or any suitable user-specific or global information that may be used by electronic media device 200. Storage device 250 may also store programs or applications that may run on control circuitry 230, may maintain files formatted to be read and edited by one or more of the applications and may store any additional files that may aid the operation of one or more applications (e.g., files with metadata). It should be understood that any of the information stored on storage device 250 may instead be stored in memory 245.

Electronic media device 200 may also include input component 220 and output component 225 for providing a user with the ability to interact with electronic media device 200. For example, input component 220 and output component 225 may provide an interface for a user to interact with an application running on control circuitry 230. Input component 220 may take a variety of forms, such as a keyboard/keypad, trackpad, mouse, click wheel, button, stylus or touch screen. Input component 220 may also include one or more devices for user authentication (e.g., smart card reader, fingerprint reader or iris scanner) as well as an audio input device (e.g., a microphone) or a video input device (e.g., a camera or a web cam) for recording video or still frames. Output component 225 may include any suitable display, such as a liquid crystal display (LCD) or a touch screen display, a projection device, a speaker or any other suitable system for presenting information or media to a user. Output component 225 may be controlled by graphics circuitry 235. Graphics circuitry 235 may include a video card, such as a video card with 2D, 3D or vector graphics capabilities. In some embodiments, output component 225 may also include an audio component that is remotely coupled to electronic media device 200. For example, output component 225 may include a headset, headphones or ear buds that may be coupled to electronic media device 200 with a wire or wirelessly (e.g., Bluetooth headphones or a Bluetooth headset).

Electronic media device 200 may have one or more applications (e.g., software applications) stored on storage device 250 or in memory 245. Control circuitry 230 may be configured to execute instructions of the applications from memory 245. For example, control circuitry 230 may be configured to execute a media player application that causes full-motion video or audio to be presented or displayed on output component 225. Other applications resident on electronic media device 200 may include, for example, a telephony application, a GPS navigator application, a web browser application and a calendar or organizer application. Electronic media device 200 may also execute any suitable operating system, such as a Mac OS, Apple iOS, Linux or Windows and can include a set of applications stored on storage device 250 or memory 245 that is compatible with the particular operating system.

In some embodiments, electronic media device 200 may also include communications circuitry 255 to connect to one or more communications networks. Communications circuitry 255 may be any suitable communications circuitry operative to connect to a communications network and to transmit communications (e.g., voice or data) from electronic media device 200 to other devices within the communications network. Communications circuitry 255 may be operative to interface with the communications network using any suitable communications protocol such as, for example, Wi-Fi (e.g., a 802.11 protocol), Bluetooth, high frequency systems (e.g., 900 MHz, 2.4 GHz and 5.6 GHz communication systems), infrared, GSM, GSM plus EDGE, CDMA, quadband and other cellular protocols, VOIP or any other suitable protocol.

In some embodiments, communications circuitry 255 may be operative to create a communications network using any suitable communications protocol. Communications circuitry 255 may create a short-range communications network using a short-range communications protocol to connect to other devices. For example, communications circuitry 255 may be operative to create a local communications network using the Bluetooth protocol to couple with a Bluetooth headset (or any other Bluetooth device). Communications circuitry 255 may also include a wired or wireless network interface card (NIC) configured to connect to the Internet or any other public or private network. For example, electronic media device 200 may be configured to connect to the Internet via a wireless network, such as a packet radio network, an RF network, a cellular network or any other suitable type of network. Communication circuitry 245 may be used to initiate and conduct communications with other communications devices or media devices within a communications network.

Electronic media device 200 may also include any other component suitable for performing a communications operation. For example, electronic media device 200 may include a power supply, an antenna, ports or interfaces for coupling to a host device, a secondary input mechanism (e.g., an ON/OFF switch) or any other suitable component.

Electronic media device 200 may also include POM sensors 260. POM sensors 260 may be used to determine the approximate geographical or physical location of electronic media device 200. As described in more detail below, the location of electronic media device 200 may be derived from any suitable trilateration or triangulation technique, in which case POM sensors 260 may include an RF triangulation detector or sensor or any other location circuitry configured to determine the location of electronic media device 200.

POM sensors 260 may also include one or more sensors or circuitry for detecting the position orientation or movement of electronic media device 200. Such sensors and circuitry may include, for example, single-axis or multi-axis accelerometers, angular rate or inertial sensors (e.g., optical gyroscopes, vibrating gyroscopes, gas rate gyroscopes or ring gyroscopes), magnetometers (e.g., scalar or vector magnetometers), ambient light sensors, proximity sensors, motion sensor (e.g., a passive infrared (PIR) sensor, active ultrasonic sensor or active microwave sensor) and linear velocity sensors. For example, control circuitry 230 may be configured to read data from one or more of POM sensors 260 in order to determine the location orientation or velocity of electronic media device 200. One or more of POM sensors 260 may be positioned near output component 225 (e.g., above, below or on either side of the display screen of electronic media device 200).

FIG. 27 depicts an illustrative rendering of one particular electronic media device 280. Device 280 includes a multipurpose button 282 as an input component, a touch screen display 284 as a both an input and output component, and a speaker 285 as an output component, all of which are housed within a device housing 290. Device 280 also includes a primary receptacle connector 286 and an audio plug receptacle 288 within device housing 290. Each of the receptacle connectors 286 and 288 can be positioned within housing 290 such that the cavity of the receptacle connectors into which a corresponding plug connector is inserted is located at an exterior surface of the device housing. In some embodiments, the cavity opens to an exterior side surface of device 280. For simplicity, various internal components, such as the control circuitry, graphics circuitry, bus, memory, storage device and other components are not shown in FIG. 27. Receptacle connectors according to embodiments of the invention are particularly suitable to be used as either or both of primary receptacle 286 or audio plug receptacle 288. Additionally, in some embodiments, electronic media device 280 has only a single receptacle connector that is used to physically interface and connect the device (as opposed to a wireless connection) to the other electronic devices. Embodiments of the invention are also particularly suitable for such a connector.

As will be understood by those skilled in the art, the present invention may be embodied in many other specific forms without departing from the essential characteristics thereof. As an example, while a number of embodiments illustrated above included ground contacts that were incorporated into the retention features, both in the plug connector as well as the receptacle connector, other embodiments of the invention may include ground contacts along portions of the side or tip of the connector that is not part of a retention mechanism. Similarly, some embodiments may include ground contacts within one or more of contact regions 46a and 46b to obtain improved ground coverage. The inclusion of ground contacts in one or more of contact regions 46a and 46b may be in addition to or instead of the ground contacts outside of the contact regions. In some such embodiments, ground contacts are placed in each of regions 46a and 46b in a cater cornered relationship. As specific examples, a pair of ground contacts can be included in any of connectors 110, 120, 130, 140 or 150 described above in the place of any one of the pairs of similarly purposed data contacts described with respect to those connectors. For example, a pair of ground contacts could be included instead of the pair of data contacts A and B shown in connectors 110 and 150; in place of the pair of contacts Dx and Dy shown in connectors 110, 140 and 150; in place of any of the pairs of contacts DP1/DN1 or DP2/DN2 shown in connectors 120, 130 and 140; or in place of any of the pairs of contacts LN0±, LN1±, Ln2±or LN3±shown in connector 150. As another example, various embodiments of the invention were described above with respect to dual orientation connectors. Other embodiments include connectors that have more than two possible insertion orientations. For example, a connector system could include a plug connector that has a triangular cross-section to fit within a corresponding receptacle connector in any one of three possible orientations, a square cross-section and fits within a receptacle connector in any one of four possible insertion orientations, a hexagonal cross-section to fit within a corresponding receptacle connector in any one of six possible orientations, etc.

Also, while a number of specific embodiments were disclosed with specific features, a person of skill in the are will recognize instances where the features of one embodiment can be combined with the features of another embodiment. For example, some specific embodiments of the invention set forth above were illustrated with pockets as retention features. A person of skill in the art will readily appreciate that any of the other retention features described herein, as well as others not specifically mentioned, may be used instead of or in addition to the pockets. Also, those skilled in the art will recognize, or be able to ascertain using no more than routine experimentation, many equivalents to the specific embodiments of the inventions described herein. Such equivalents are intended to be encompassed by the following claims.

What is claimed is:

1. A plug connector comprising:
a body;
a connector tab extending longitudinally away from the body, the connector tab having first and second major opposing surfaces;
a first contact region formed at the first major surface of the tab, the first contact region including a first plurality of external contacts spaced apart and along a first row, the first plurality of contacts consisting of an odd number of contacts including a first central contact centered in the first row dedicated for a first digital data signal;
a second contact region formed at the second major surface of the tab, the second contact region including a second plurality of external contacts spaced apart along a second row directly opposite the first row, the second plurality of contacts consisting of the same number of contacts as the first plurality of contacts and including a second central contact centered in the second row dedicated for a second digital data signal; and
wherein the tab is shaped and the first and second plurality of contacts are arranged to have 180 degree symmetry so that the tab can be inserted and operatively coupled to a corresponding receptacle connector in either of two orientations.

2. The plug connector set forth in claim 1 wherein the first and second digital data signals represent a pair of differential data signals.

3. The plug connector set forth in claim 1 wherein the first and second contact regions further include a pair of power contacts positioned in a cater corner relationship with each other.

4. The plug connector set forth in claim 1 wherein the first and second contact regions further include a second pair of differential data contacts positioned in a cater corner relationship with each other.

5. The plug connector set forth in claim 1 wherein the first and second contact regions further include a four pairs of differential data contacts, including first and second pairs of differential data contacts positioned in a cater corner relationship with each other and third and fourth pairs of differential data contacts positioned in a cater corner relationship with each other.

6. The plug connector set forth in claim 1 wherein the first and second contact regions further include a pair of ground contacts positioned in a cater corner relationship with each other.

7. A plug connector comprising:
a body;
a connector tab extending longitudinally away from the body, the connector tab having first and second major opposing surfaces;
a first contact region formed at the first major surface of the tab, the first contact region including a first plurality of external contacts spaced apart and along a first row, the first plurality of contacts consisting of an even number of at least four contacts including first and second innermost contacts where the first innermost contact is dedicated for a first digital data signal and the second innermost contact is dedicated for power;
a second contact region formed at the second major surface of the tab, the second contact region including a second plurality of external contacts spaced apart along a second row directly opposite the first row, the second plurality of contacts consisting of the same number of contacts as the first plurality of contacts including third and fourth innermost contacts where the third innermost contact is in a cater corner position with respect to the first innermost contact and is dedicated for a second digital data signal and the fourth innermost contact is in a cater corner position with respect to the second innermost contact and is dedicated for power; and
wherein the tab is shaped and the first and second plurality of contacts are arranged to have 180 degree symmetry so that the tab can be inserted and operatively coupled to a corresponding receptacle connector in either of two orientations.

8. The plug connector set forth in claim 7 wherein the first and second digital data signals represent a pair of differential data signals.

9. The plug connector set forth in claim 7 wherein the first and second contact regions further include a pair of ground contacts positioned in a cater corner relationship with each other.

10. The plug connector set forth in claim 8 wherein the first and second contact regions further include a second pair of differential data contacts positioned in a cater corner relationship with each other.

11. The plug connector set forth in claim 7 wherein the first and second contact regions further include a four pairs of differential data contacts, including first and second pairs of differential data contacts positioned in a cater corner relationship with each other and third and fourth pairs of differential data contacts positioned in a cater corner relationship with each other.
